(19) United States
(12) Patent Application Publication
(10) Pub. No.: US 2013/0211804 A1
(43) Pub. Date: Aug. 15, 2013

(54) SIMULATION APPARATUS, SIMULATION METHOD AND A NON-TRANSITORY COMPUTER-READABLE RECORDING MEDIUM

(71) Applicants: Takashi Yamada, Tokyo (JP); Toshie Furubayashi, Tokyo (JP); David Christopher Dibben, Osaka (JP); Hiroshi Hashimoto, Tokyo (JP); Yoshiyuki Sakashita, Tokyo (JP); Hiroyuki Sano, Tokyo (JP)

(72) Inventors: Takashi Yamada, Tokyo (JP); Toshie Furubayashi, Tokyo (JP); David Christopher Dibben, Osaka (JP); Hiroshi Hashimoto, Tokyo (JP); Yoshiyuki Sakashita, Tokyo (JP); Hiroyuki Sano, Tokyo (JP)

(73) Assignee: JSOL CORPORATION, Tokyo (JP)

(21) Appl. No.: 13/704,574

(22) PCT Filed: Dec. 6, 2011
(86) PCT No.: PCT/JP11/78221

§ 371 Date: Dec. 14, 2012

(51) Int. Cl. G06F 17/50

(52) U.S. Cl. CPC G06F 17/5009
USPC 703/6

(57) ABSTRACT

A simulation apparatus is provided with means for obtaining shape data expressing a simulation object, means for storing a constraint condition for a simulation in association with each type of object, means for storing, for each of one or more evaluation items for evaluating an object having an arbitrary shape satisfying the constraint condition, a procedure of a coupled analysis using one or more simulation means related to the evaluation item, means for accepting a type and an evaluation item for an object, means for reading out a procedure of a coupled analysis corresponding to the evaluation item based on the accepted evaluation item for the object, and means for reading out a constraint condition for an object corresponding to the accepted type and giving the constraint condition to the shape data to execute the coupled analysis in accordance with the procedure of the coupled analysis.

This application is the national phase under 35 U.S.C. §371 of PCT International Application No. PCT/JP2011/078221 which has an International filing date of Dec. 6, 2011 and designated the United States of America.

### FIELD

The present invention relates to a simulation apparatus, a simulation method and a computer program used for performing a coupled analysis simulation by CAE (Computer Aided Engineering).

### BACKGROUND

CAE is generally utilized in design and development of devices (see Japanese Patent Application Laid-Open No. 2010-026595 for example). By numerically analyzing the performance of a device using CAE, the development cost can be reduced compared to conventional performance tests which repeat production of a number of experimental productions.

Since the numeric analysis of devices using CAE is highly specialized for each physical phenomenon, an analysis and performance evaluation were conventionally performed individually by a specialist in each field. If, for example, a torque, a loss or the like of a motor is to be evaluated, a specialist for an electromagnetic analysis evaluates the performance of a device using electromagnetic field analysis CAE. If the strength of a motor, a housing or the like is to be evaluated, a specialist for a structure analysis evaluates the performance of a device utilizing structure analysis CAE. Moreover, a specialist for thermo-fluid analysis utilizes thermo-fluid analysis CAE to review a cooling mechanism and to design heat removal in order to prevent the motor from abnormally generating heat and improperly operating.

As described above, the performance of a device is evaluated in terms of each of the electromagnetic field analysis, structure analysis and thermo-fluid analysis, so that the design is optimized in each field. The design, however, may not necessarily be optimal as the entire system. If, for example, the torque of the motor is to be maximized, a structure with a magnet provided on the surface of a rotator may be considered to be optimal in the field of electromagnetic analysis. Considering, however, such a problem in the structural strength that the magnet could be removed from the rotator at high speed rotation, the simple structure only having the magnet on the surface of the rotator is not recognized as optimal.

As a numeric analyzing method for solving the above-described problem, a coupled analysis simulation has been proposed, which couples analysis simulators in different fields with each other to perform numeric analyses. In recent years, with the increased speed of computers, an analysis environment for performing the coupled analysis simulation within a realistic time period for design development has been in place.

### SUMMARY

In order to realize a numeric analysis utilizing the coupled analysis simulation, however, it is necessary to (1) have a highly specialized knowledge for all physical phenomena related to evaluation of the performance of a device, (2) conduct a long-term verification by preparing models required for analyses in different fields, and (3) correctly grasp the relationship between fields to combine inputs and outputs. A problem, therefore, is caused in that a coupled analysis simulation cannot be introduced in a short period of time in the actual field of device design.

In such a circumstance, it may be faster to verify an experimentally-manufactured machine than to gather specialists for analyses in different fields, to create a process flow for a coupled analysis and to perform a numeric analysis.

Even if the coupled analysis simulation can be realized for evaluation for the performance of a device, there is no way of reusing the know-how thereof, causing such a problem that the know-how cannot be utilized in evaluating the performance of another device.

The present invention has been contrived in view of the above circumstances. An object of the invention is to provide a simulation apparatus, a simulation method and a computer program, which can easily execute a performance evaluation using the coupled analysis simulation by including a coupled analysis procedure storage means for storing a coupled analysis flow for an object satisfying a constraint condition provided for each type of simulation object, so as to provide the coupled analysis flow with general versatility.

A simulation apparatus according to the present invention is characterized by including: shape data obtaining means for obtaining shape data expressing a simulation object; constraint condition storage means for storing a constraint condition for a simulation in association with each type of object; one or more simulation means for simulating behavior of an object having an arbitrary shape satisfying the constraint condition based on one or more different governing equations; coupled analysis procedure storage means for storing, for each of one or more evaluation items for evaluating an object having an arbitrary shape satisfying the constraint condition, a procedure of a coupled analysis using said one or more simulation means related to the evaluation item; accepting means for accepting a type of an object regarding the obtained shape data and an evaluation item for the object; reading means for reading out a procedure of a coupled analysis corresponding to the evaluation item from the coupled analysis procedure storage means based on the accepted evaluation item for the object; and coupled analysis means for reading out a constraint condition for an object corresponding to the accepted type from the constraint condition storage means, giving the constraint condition to the shape data, and executing the coupled analysis using the above-described one or more simulation means in accordance with the procedure of the coupled analysis read out by the reading means.

The simulation apparatus according to the present invention is characterized by including a plurality of simulation means for simulating behavior of an object having an arbitrary shape satisfying the constraint condition based on one or more different governing equations.

The simulation apparatus according to the present invention is characterized in that the above-described one or more different simulation means is configured to simulate or optimize behavior of an object based on a governing equation expressing electromagnetic behavior, mechanical behavior, thermal behavior, behavior related to an electric circuit or fluxional behavior of the object, or based on an optimizing method for each behavior.

A simulation apparatus according to the present invention is characterized in including means for displaying a flow chart illustrating the procedure of the coupled analysis read out by the reading means, and the flow chart includes a processing node indicating processing to be executed by the simulation means, a data node indicating data to be input or output by the simulation means.

The simulation apparatus according to the present invention is characterized by including means for extracting a certain execution procedure part included in the procedure of the coupled analysis read out by the reading means and generating a procedure for another coupled analysis different from the procedure.

The simulation apparatus according to the present invention is characterized by including partial execution means for executing a certain execution procedure part included in the procedure of the coupled analysis read out by the reading means independently of another execution procedure part.

The simulation apparatus according to the present invention is characterized by including means for displaying a flow chart illustrating the procedure of the coupled analysis read out by the reading means; and means for displaying a designation image on the flow chart for designating a beginning and an end of a certain execution procedure part included in the procedure of the coupled analysis, and is characterized in that the partial execution means is configured to execute the execution procedure part designated by the designation image independently of another execution procedure part.

The simulation apparatus according to the present invention is characterized in that the simulation means includes means for creating a file including a simulation result, the simulation apparatus further including: result display means for displaying a simulation result regarding the evaluation item in a simplified manner based on the file; detailed display accepting means for accepting a detailed display of the simulation result displayed by the result display means; means for searching for a file related to the simulation result accepted by the detailed display accepting means; and means for making the simulation means which has created the file related to the simulation result open the file.

A simulation method according to the present invention for simulating behavior of an object using a simulation apparatus including: constraint condition storage means for storing a constraint condition for a simulation in association with each type of simulation object; one or more simulation means for simulating behavior of an object having an arbitrary shape satisfying the constraint condition based on a plurality of different governing equations; and coupled analysis procedure storage means for storing, for each of one or more evaluation items for evaluating an object having an arbitrary shape satisfying the constraint condition, a procedure of a coupled analysis using the above-described one or more simulation means related to the evaluation item, is characterized by including the steps of: obtaining shape data for an object; accepting a type of an object regarding the obtained shape data and an evaluation item for the object; reading out a procedure of a coupled analysis corresponding to the evaluation item from the coupled analysis procedure storage means based on the accepted evaluation item of the object; and reading out a constraint condition of an object corresponding to the accepted type from the constraint condition storage means, giving the constraint condition to the shape data, and executing the coupled analysis using the above-described one or more simulation means in accordance with the read-out procedure of the coupled analysis.

A computer program according to the present invention for making a computer simulate behavior of an object, the computer including: constraint condition storage means for storing a constraint condition for a simulation in association with each type of simulation object; one or more different simulation means for simulating behavior of an object having an arbitrary shape satisfying the constraint condition based on a plurality of different governing equations; and coupled analysis procedure storage means for storing, for each of one or more evaluation items for evaluating an object having an arbitrary shape satisfying the constraint condition, a procedure of a coupled analysis using the above-described one or more simulation means related to the evaluation item, is characterized by making the computer function as: an accepting means for accepting a type of an object regarding the shape data of an object and an evaluation item for the object; reading means for reading out a procedure of a coupled analysis corresponding to the evaluation item from the coupled analysis procedure storage means based on the accepted evaluation item for the object; and coupled analysis means for reading out a constraint condition for an object corresponding to the accepted type from the constraint condition storage means, giving the constraint condition to the shape data, and executing the coupled analysis using the above-described one or more simulation means in accordance with the procedure of the coupled analysis read out by the reading means.

According to the present invention, a constraint condition is associated with each type of object, while the coupled analysis procedure storage means stores a procedure of a coupled analysis using one or more different simulation means related to an evaluation item for each one or more evaluation items for evaluating an object having an arbitrary shape satisfying the constraint condition. The coupled analysis procedure storage means does not store a procedure of a coupled analysis for evaluating individual objects, but stores a procedure of a coupled analysis for evaluating an object having an arbitrary shape satisfying a specific constraint condition. It is thus possible to provide the procedure of coupled analysis with general versatility. In other words, it is possible to share the procedure of coupled analysis among the objects satisfying the same constraint condition even if the objects have different shape data.

A designer of an object can input a type of object and an evaluation item to read out the procedure for the coupled analysis corresponding to the evaluation item from the coupled analysis procedure storage means, provides the mere shape data which does not have a meaning for an object, i.e. a real machine, with a constraint condition, and executes the coupled analysis.

According to the present invention, it is possible to perform a coupled analysis in consideration of various physical phenomena using a plurality of simulation means for simulating behavior of an object having an arbitrary shape satisfying a constraint condition based on one or more different governing equations.

According to the present invention, a coupled analysis can be performed for an electromagnetic analysis, a mechanical analysis, a thermal analysis, a flow analysis and an analysis regarding an electric circuit, to simulate behavior of an object. Moreover, a simulation for optimizing these can be performed.

According to the present invention, a flow chart illustrating the procedure of coupled analysis can be shown, the flow chart including at least a process node and a data node. Data for inputting to or outputting from a simulator can be defined as a data node.

According to the present invention, a certain execution procedure part included in the coupled analysis procedure can be extracted to generate a procedure for another coupled analysis different from the above-described procedure. It is, therefore, possible to pull out a part of the coupled analysis procedure to divert it to the procedure for another coupled analysis. It is also possible to pull out a part of the procedure and check the operation of a relevant portion. Note that an alteration can be added in creating a procedure for another coupled analysis. For example, a part of the extracted execution procedure part may be deleted or another process execution procedure may be added.

According to the present invention, a certain execution procedure part included in the coupled analysis procedure may be executed by partial execution. As only a part of the complicated coupled analysis procedure is taken out to be executed and evaluated, it is possible to further understand the coupled analysis procedure and to easily perform an analysis when an abnormality occurs in operation.

According to the present invention, a certain execution procedure part included in the coupled analysis procedure can be designated on a flow chart.

According to the present invention, a simulation result is displayed in a simplified manner based on a file including the result of simulation. The number of files may be one or more, while the simulation result is edited and displayed in a form viewable by the user such that the user can easily check the details of the evaluation items. When a detailed display is accepted, a corresponding related file, on which the analysis result is based, is searched for and a simulation means which has created the file opens the file. The user can analyze details of the simulation result for the evaluation items.

According to the present invention, the coupled analysis flow can be provided with general versatility, and thus the performance evaluation making use of the coupled analysis simulation can easily be executed.

The above and further objects and features will more fully be apparent from the following detailed description with accompanying drawings.

### BRIEF DESCRIPTION OF THE SEVERAL VIEWS OF THE DRAWINGS

FIG. 1 is a block diagram illustrating one configuration example of a simulation apparatus according to an embodiment of the present invention;

FIG. 2 is an explanatory view illustrating a concept of a simulation method according to an embodiment of the present invention;

FIG. 3 is a flow chart illustrating the simulation method according to an embodiment of the present invention;

FIG. 4 is a schematic view illustrating an example of a type selection screen for a simulation object;

FIG. 5 is a schematic view illustrating another example of a type selection screen for a simulation object;

FIG. 6 is a schematic view illustrating an example of a screen for evaluation item selection;

FIG. 7 is a schematic view illustrating an example of a screen for a result of the evaluation item selection;

FIG. 8 is a schematic view illustrating an example of a flow display screen;

FIG. 9 is a flow chart conceptually illustrating an example of a procedure of a coupled analysis;

FIG. 10 is an explanatory view illustrating an example of analysis data generated by the coupled analysis procedure;

FIG. 11 is a flow chart conceptually illustrating another example of the coupled analysis procedure;

FIG. 12 is a schematic view illustrating an example of a screen for a simulation result report;

FIG. 13 is a data flow chart conceptually illustrating a coupled analysis by a data node;

FIG. 14 is a flow chart illustrating a processing procedure of a subroutine regarding independent execution;

FIG. 15 is a data flow chart conceptually illustrating a method of independent execution processing;

FIG. 16 is a schematic view illustrating an example of a flow display screen for displaying the portion of a processing node for independent execution;

FIG. 17 is a flow chart illustrating a processing procedure of a subroutine regarding partial execution;

FIG. 18 is a schematic view illustrating an example of a flow display screen for accepting an object to be partially executed;

FIG. 19 is a data flow chart conceptually illustrating a method of partial execution processing;

FIG. 20 is a flow chart illustrating a processing procedure of a subroutine regarding an output of an analysis result;

FIG. 21 is a flow chart illustrating an example of the coupled analysis procedure;

FIG. 22 is a schematic view illustrating the screen for a simulation result report and a start-up screen for a related file by a simulator;

FIG. 23 is a conceptual view illustrating a method of searching the related file;

FIG. 24 is a schematic view illustrating the screen for a simulation result report and a start-up screen for another related file by a simulator;

FIG. 25 is a conceptual view illustrating a method of searching another related file;

FIG. 26 is a conceptual view illustrating a method of coupled analysis for evaluating noise generated from a motor in consideration of imperfect magnetization of a magnet;

FIG. 27 is a conceptual view illustrating a method of coupled analysis for evaluating a raise in temperature in consideration of thermal expansion at the time of energization heating or induction heating;

FIG. 28 is a conceptual view illustrating a method of coupled analysis for obtaining a basic characteristic of a motor; and

FIG. 29 is a conceptual view illustrating a method of coupled analysis related to a separation analysis for a torque component.

### DETAILED DESCRIPTION OF NON-LIMITING EXAMPLE EMBODIMENTS

The present invention will now be described below with reference to drawings illustrating the embodiments thereof.

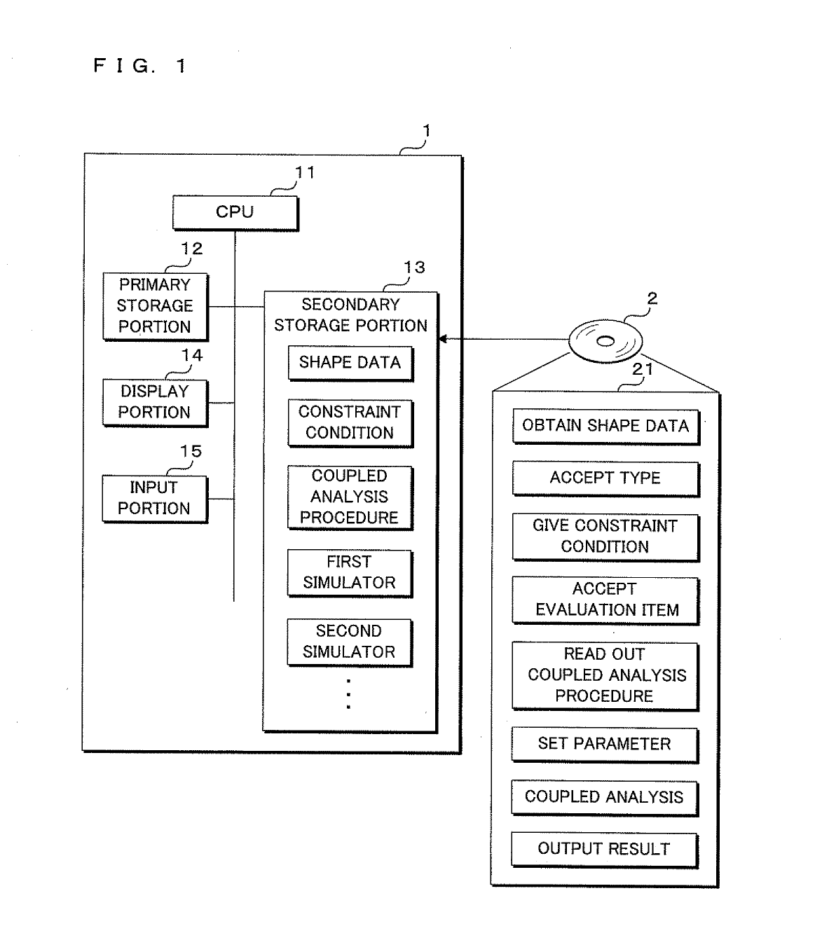

FIG. 1 is a block diagram illustrating a configuration example of a simulation apparatus 1 according to the present embodiment. The simulation apparatus 1 is a computer including a CPU (Central Processing Unit) 11 for controlling the operation of each component in the simulation apparatus 1. The CPU 11 is connected to a primary storage portion 12, a secondary storage portion 13, a display portion 14 and an input portion 15 via a bus.

The primary storage portion 12 is configured with, for example, a ROM, a RAM or the like. A ROM is a non-volatile memory such as a mask ROM, an EEPROM or the like storing a control program required for the operation of a computer. A RAM is a volatile memory such as a DRAM, a SRAM or the like temporarily storing a control program required for the operation of a computer and various kinds of data generated in executing an operation process in the CPU 11.

The secondary storage portion 13 is configured with a hard disk drive, a solid state drive and a CD-ROM drive capable of reading from a portable recording medium. The secondary storage portion 13 stores shape data which is a simulation object, e.g., CAD data. Moreover, the secondary storage portion 13 stores a constraint condition for a simulation by associating it with each type of object. To an object type “motor,” for example, a constraint condition such that the object has a rotor and a stator as well as a three-phase coil, that the three-phase coil is on the stator side, that the object has a magnet, or that the magnet is on the rotor side is associated. Moreover, associated with an object type “transformer,” is a constraint condition such that, for example, the object has a primary coil and a secondary coil, that the object has a core, or that the primary coil and the secondary coil are wound around the core. Furthermore, the secondary storage portion 13 stores, together with the constraint conditions, a parameter to be set when a simulation for an object is executed for each type of object. Note that the constraint condition to be associated with a “type” and the parameter are not necessarily determined uniquely. A winding type of the motor, for example, may be treated as any one of the constraint condition and the parameter. Whether the condition to be set for a “type” is defined as a constraint condition or a parameter may appropriately be determined in accordance with the utilization of a simulation.

Furthermore, the secondary storage portion 13 stores a plurality of simulator programs for simulating behavior of an object having an arbitrary shape satisfying the constraint condition based on a plurality of different governing equations, and a procedure for a coupled analysis using a plurality of simulators associated with an evaluation item for, the procedure being for each of one or more evaluation items for evaluating the object having an arbitrary shape satisfying the constraint condition. The plurality of simulator programs are programs for simulating behavior of an object based on a governing equation expressing electromagnetic behavior, mechanical behavior, thermal behavior, behavior related to an electric circuit or fluxional behavior of the object, and are corresponding to the first simulator, the second simulator, etc. in FIG. 1. Moreover, a computer program for optimizing each behavior based on a known optimizing method may also be included. An example of the governing equation expressing the electromagnetic behavior includes the Maxwell's equation, while an example of the governing equation expressing the mechanical behavior includes an equation of equilibrium based on the Hooke's law or the Newton's equation. An example of the governing equation expressing the thermal behavior includes a thermal conduction equation, while examples of the governing equation expressing the fluxional behavior include the Navier-Stokes' equation and the Euler's equation based on, for example, a mass conservation equation, a momentum conservation equation, an energy conservation equation or the like. An example of the governing equation expressing behavior related to an electric circuit includes the Ohm's law.

The computer program 21 is recorded in a recording medium 2 such as a CD (Compact Disc)-ROM, a DVD (Digital Versatile Disc)-ROM or a BD (Blu-ray (registered trademark) Disc), which is a portable and computer-readable recording medium, or in a hard disk drive or a solid state drive. The CPU 11 reads out a computer program 21 from the recording medium 2, the hard disk drive or the like and stores it in the primary storage portion 12. The computer program 21 of the present invention may also be downloaded from an external computer (not shown) connected to a communication network to be stored in the secondary storage portion 13.

The input portion 15 is an input device such as a keyboard or a mouse, which accepts an operation such as an input of a type of a simulation object and an evaluation item or a parameter setting.

The display portion 14 is an output device configured by an input screen for inputting shape data, a type of simulation object, an evaluation item and the like, as well as a display device such as a liquid-crystal display or a CRT display for displaying a simulation result.

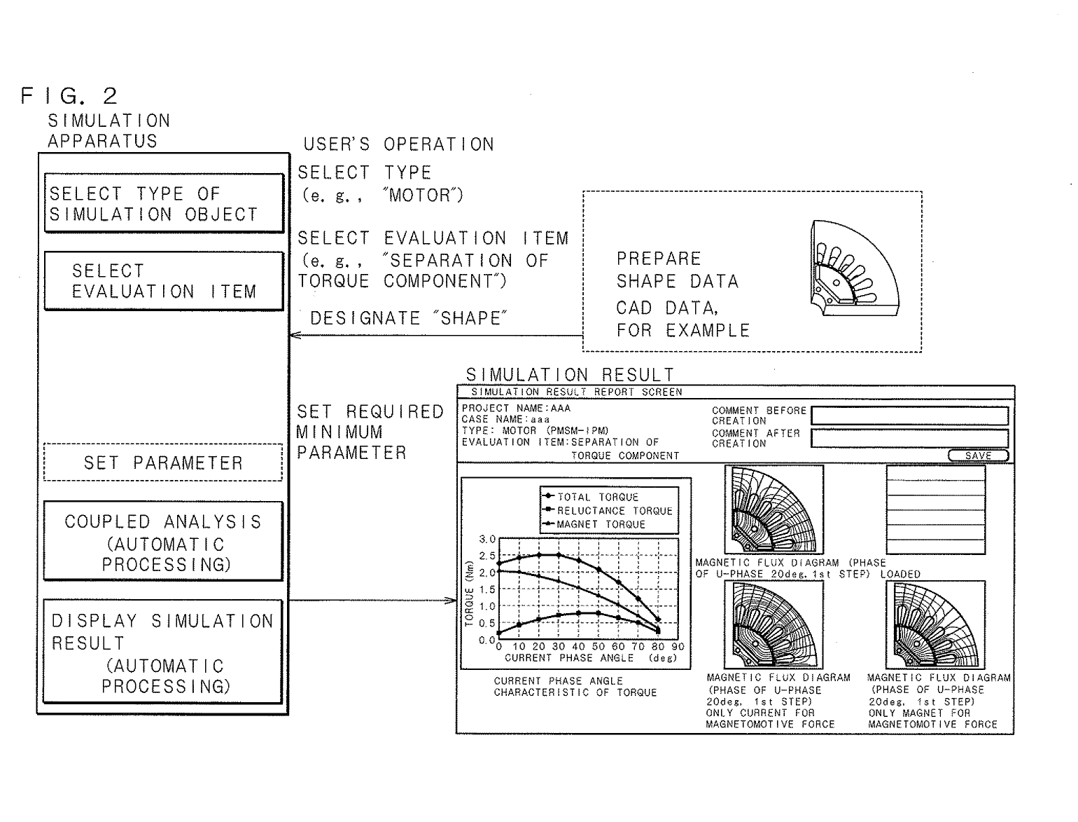

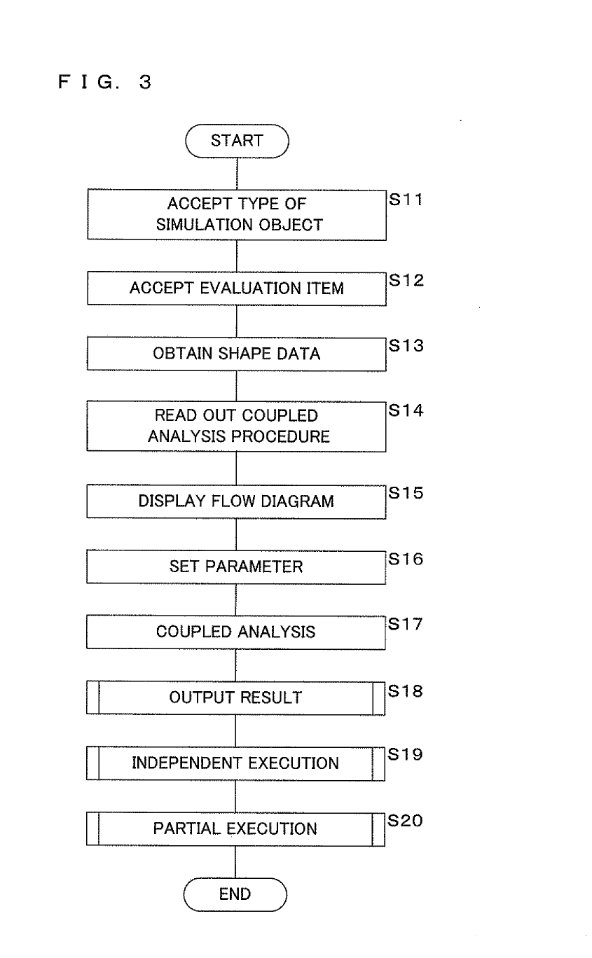

FIG. 2 is an explanatory view illustrating a concept of a simulation method according to the present embodiment. FIG. 3 is a flow chart illustrating the simulation method according to the present embodiment. The CPU 11 accepts a type of object regarding the shape data as illustrated in FIGS. 2 and 3 (Step S11). The “type” of an object is a concept for giving a constraint condition for simulation, as a characteristic of a simulation object, to the shape data basically having a meaning only as a shape. The simulation apparatus 1 stores a constraint condition for simulation with respect to the “type” as described above. In other words, the CPU 11 accepts, from the user, the constraint condition for making the simulation object be an object, as a “type.”

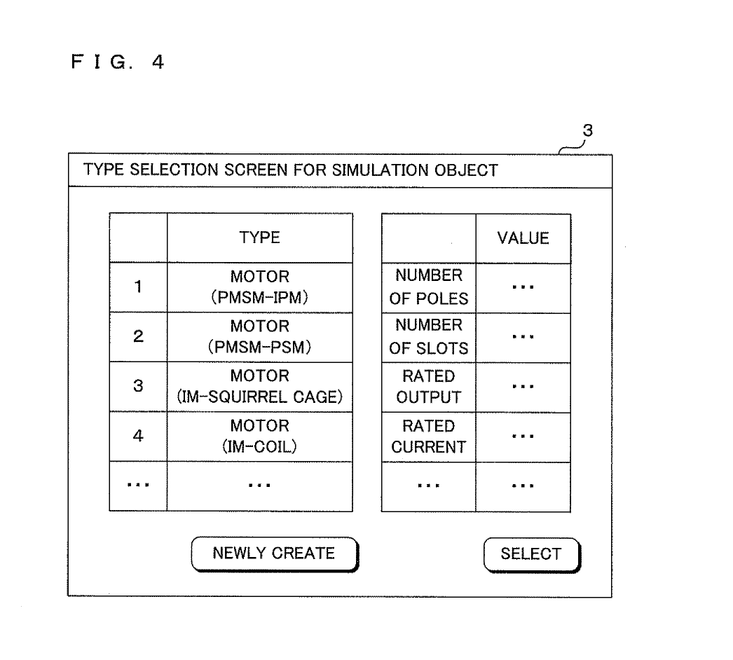

FIG. 4 is a schematic view illustrating an example of a type selection screen 3 for a simulation object. The type selection screen 3 includes a list of object types, a list of parameters to be set for each type of object, a button for newly creating (hereinafter referred to as “newly create button” and a button for selecting (hereinafter referred to as “select button”). The CPU 11 reads out a type of object from the secondary storage portion 13, generates a list of the read-out objects and displays the generated list on a part of the window screen, e.g., on the left side. As the “type,” for example, “motor (PMSM-IPM),” “motor (PMSM-PSM),” “motor (IM-squirrel cage),” or “motor (IM-coil)” is shown.

Furthermore, the CPU 11 reads out a parameter associated with the type selected with a cursor (not shown) from the secondary storage portion 13, generates a list of the read-out parameters, and displays the generated list on a part of the window screen, e.g., on the right side. When, for example, “motor (PMSM-IPM)” is selected, the “pole number,” “slot number,” “rated output” and “rated current” of the motor are displayed. If the select button is operated, the CPU 11 accepts the “type” currently selected with the cursor as the “type of object.” When the newly create button is operated, a screen for newly creating the “type” of an object is displayed. The user can input a name, a constraint condition and a parameter for the “type” to define and register a new “type.”

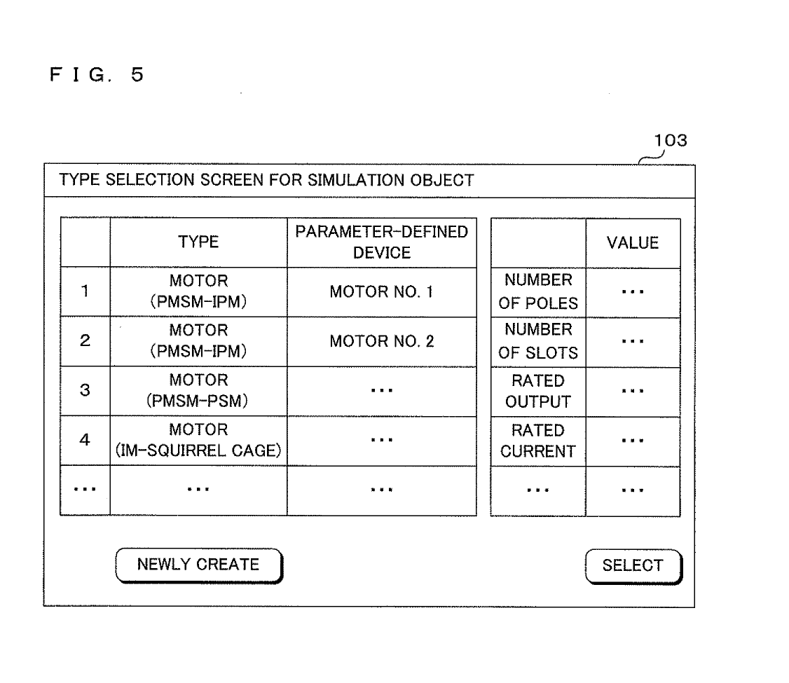

FIG. 5 is a schematic view illustrating another example of a type selection screen for a simulation object. The type selection screen 103 shown in FIG. 5 displays a list of devices for which parameters have already been defined (hereinafter also referred to as “parameter-defined devices”). The user can store a device for which a parameter value is set with respect to a “type” of an object as a “parameter-defined device” in the secondary storage portion 13. That is, the CPU 11 can store a “parameter value” in the secondary storage portion 13 by associating it with a “type.” By registering the parameter-set “type” as a “device,” a simulation using an object having the same parameter can be performed only by selecting a “device,” without the need for setting a parameter.

The CPU 11 then accepts an evaluation item of an object regarding the shape data as shown in FIGS. 2 and 3 (Step S12). The “evaluation item” is a concept for specifying a coupled analysis procedure indicating what kind of analysis model is created and how simulators are coupled with each other in order to calculate a numeric value for a performance evaluation of an object, using the shape data satisfying a specific constraint condition.

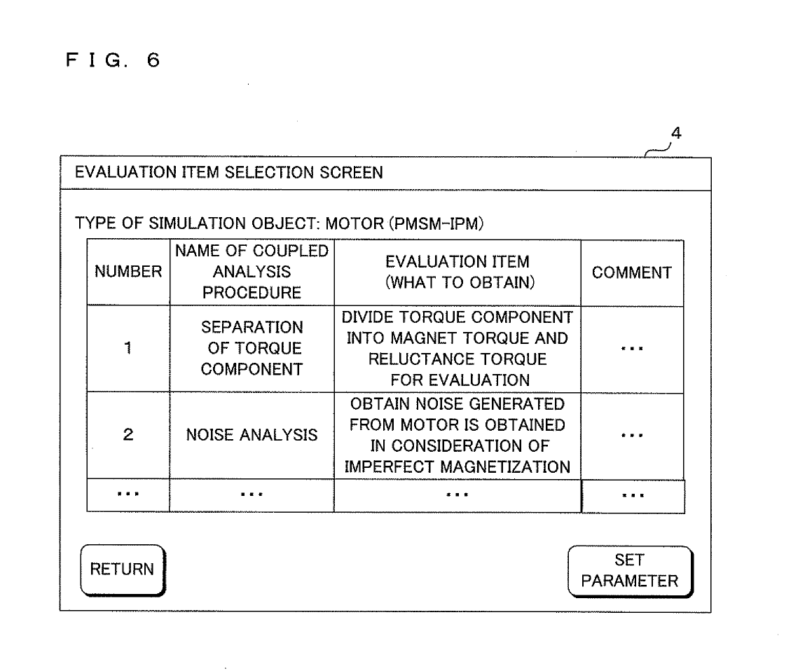

FIG. 6 is a schematic view illustrating an example of a screen for evaluation item selection (hereinafter referred to as “evaluation item selection screen”) 4. The evaluation item selection screen 4 includes a number unique to an evaluation item, a name of coupled analysis procedure, contents of the evaluation item, a list of comments, a return button and a parameter setting button. The CPU 11 reads out pieces of information related to the evaluation items from the secondary storage portion 13, generates a list of such information and displays the list on the window screen. The user can select a specific evaluation item with a cursor (not shown) and operate the parameter setting button, to select an evaluation item. The CPU 11 displays a screen for an evaluation item selection result (hereinafter referred to as “evaluation item selection result screen”) 5 when it accepts the selection of an evaluation item.

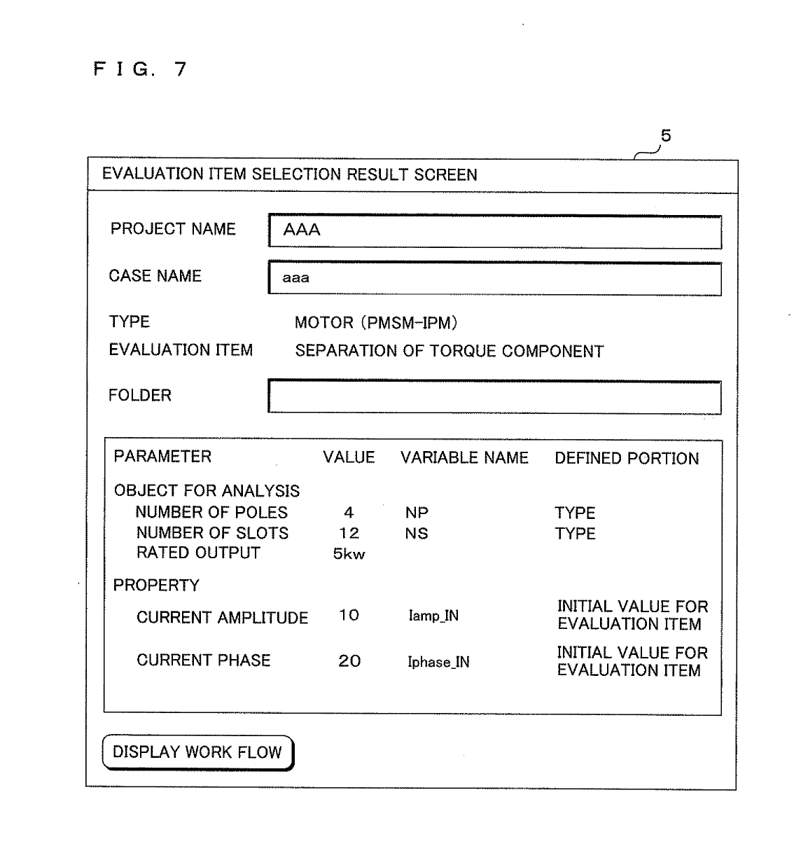

FIG. 7 is a schematic view illustrating an example of the evaluation item selection result screen 5. The evaluation item selection result screen 5 includes a project name, a case name, a type of simulation object, an evaluation item, a list of various parameters, a work flow display button and the like. The user can check details of the coupled analysis on the evaluation item selection screen 4.

Subsequently, the CPU 11 obtains shape data expressing a simulation object from the secondary storage portion 13 or from the outside (Step S13). The shape data is, for example three-dimensional CAD data expressing a three-dimensional structural object, each part of which is provided with attribute information including a material, physicality, a name and the like.

When the workflow display button is operated, the CPU 11 reads out, based on the accepted evaluation item for the object, a procedure for the coupled analysis corresponding to the evaluation item from the secondary storage portion 13 (Step S14), and displays the flow chart 61 for the read-out coupled analysis (Step S15).

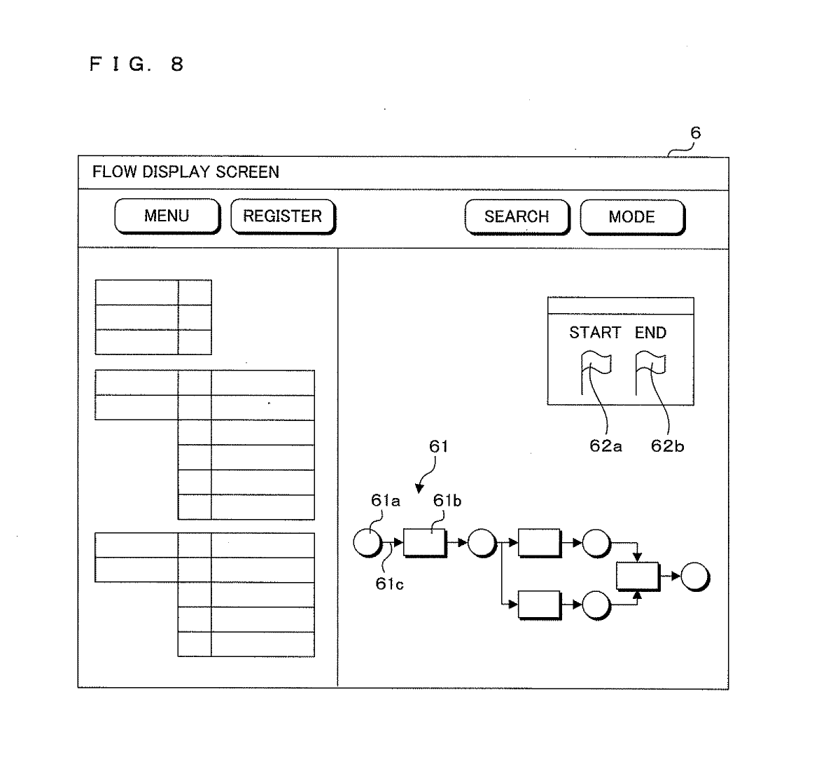

FIG. 8 is a schematic view illustrating an example of a flow display screen 6. The contents shown on the evaluation item selection result screen 5 in FIG. 7 is displayed on the left side of the flow display screen 6, while the coupled analysis procedure is shown as the flow chart 61 on the right side thereof.

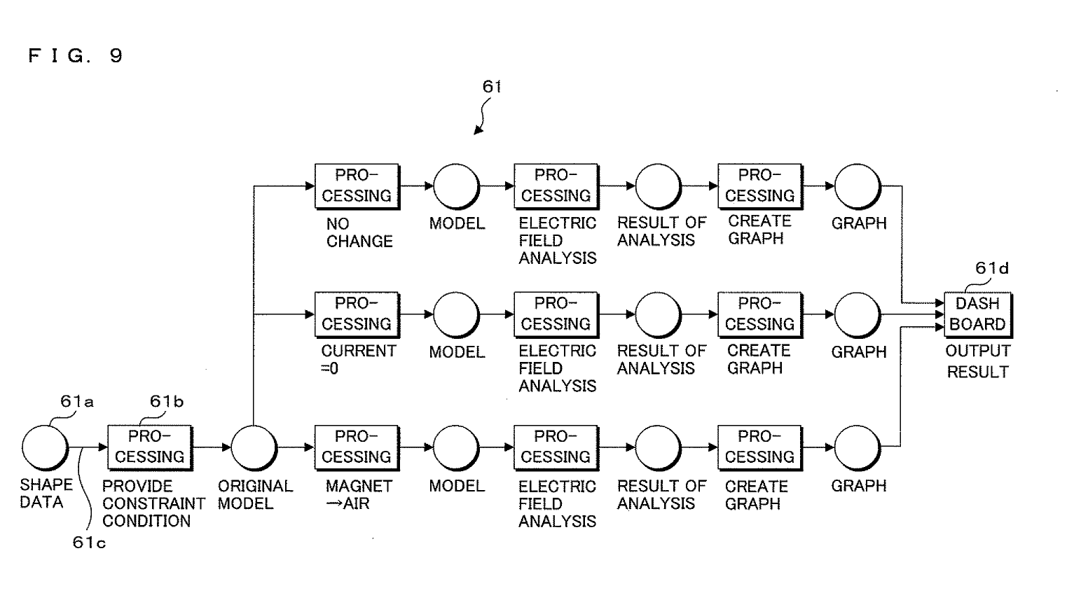

FIG. 9 is a flow chart 61 conceptually illustrating an example of the coupled analysis procedure. The flow chart 61 in FIG. 9 shows the coupled analysis procedure for numerically analyzing a torque obtained by separating a torque component of the motor into a magnet torque and a reluctance torque and analyzing a normal torque which is the sum of the magnet torque and the reluctance torque, to output a result thereof. As shown in the flow chart 61, the processing of the coupled analysis is executed in the order from the left side to the right side based on the shape data. First, a constraint condition corresponding to the accepted type is given to the shape data, and an original model is generated. In the upper flow, the normal torque is calculated by the electromagnetic analysis, and a graph is generated. In the middle flow, the magnet torque is calculated by the electromagnetic analysis, and a graph is generated. In the lower flow, the reluctance torque is calculated by the electromagnetic analysis, and a graph is generated. At a dashboard, the processing of generating and displaying the contents of evaluation items using a file obtained as a result of simulation so that even a designer who does not have a special knowledge of simulation in each field can see and verify the contents.

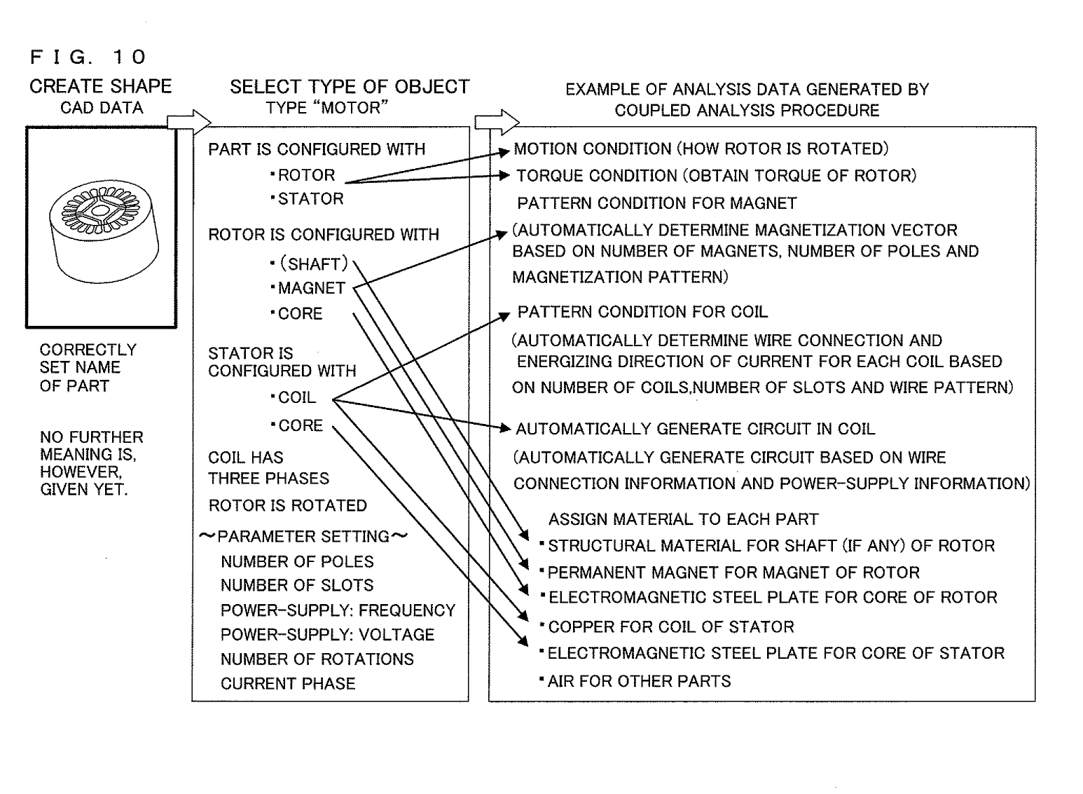

FIG. 10 is an explanatory view illustrating an example of analysis data generated by the coupled analysis procedure. At the Step S11 shown in FIG. 2, when the “motor” is accepted as a simulation object and figure data is obtained, as shown in FIG. 10, the shape data which does not have a meaning as an object is provided with a constraint condition for the “motor,” and the analysis data is generated. As the constraint condition for the type of object of “motor,” the shape data is provided with such a condition that the object has a rotor and a stator, that the rotor is configured with a shaft, a magnet and a core, that the stator is configured with a coil and a core, that the coil has three phases, or that the rotor is rotated. Furthermore, parameters are set for the number of pole, number of slot, power supply frequency, power supply voltage, number of rotations and electric current phase.

In accordance with the coupled analysis procedure, how the rotor portion is rotated and the condition that the torque to be calculated is a rotor torque are then automatically set for the shape data satisfying these constraint conditions. Moreover, as a pattern condition of a magnet, distribution of magnetization vector or the like is automatically set on the basis of the number of magnets, the number of pole and the magnetization pattern. Furthermore, as the pattern condition for the coil, the wire connection and energizing direction of current for each coil are automatically set based on the number of coils, the number of slots, and the wire pattern. In addition, a circuit for driving the motor is automatically generated based on the wire connection information and the power supply information. Moreover, a material is assigned to each part of the shape data. For example, a structural material is assigned to the shaft portion of the rotor, a permanent magnet to the rotor, an electromagnetic steel plate to the core of the rotor, copper to the coil of the stator, an electromagnetic steel plate to the core of the rotor, and the air to the other portions.

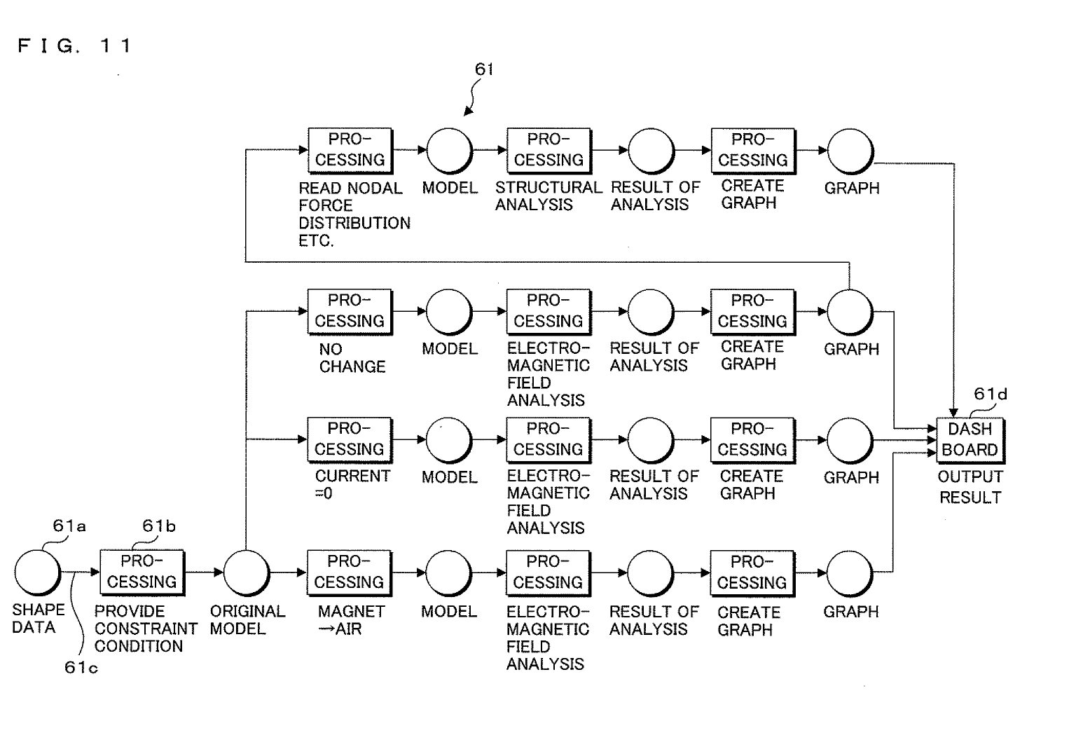

FIG. 11 is a flow chart conceptually illustrating another example of the coupled analysis procedure. In the flow chart in FIG. 11, a vibration analysis procedure for the motor is added to the coupled analysis procedure shown in FIG. 9.

The CPU 11 which has completed the processing at the step S15 accepts the setting for a parameter required for the coupled analysis (Step S16).

Note that the order of the Steps S11 to S16 may partly be changed in execution.

Subsequently, the CPU 11 executes the coupled analysis using a plurality of simulators in accordance with the procedure of the coupled analysis read out at the Step S14 (Step S17), and outputs the analysis result (Step S18).

In the coupled analysis procedure, the CPU 11 reads out a constraint condition for an object corresponding to an accepted type from the secondary storage portion 13 in accordance with the coupled analysis procedure, and applies the read-out constraint condition to the shape data. The CPU 11 can, for example, provide a constraint condition with reference to attribute information on the structural portion of the shape data. When, for example, the stator portion and rotor portion in the three-dimensional CAD data of the motor is provided with attribute information indicating that they are a stator and a rotor, the portions are stored as the stator and the rotor, respectively. If the shape data is not provided with attribute information, the information required for creating an analysis model in accordance with the constraint condition may be accepted from the user. When, for example, the coil portion is unidentified, the CPU 11 accepts the designation for the coil portion from the user, and identifies the coil portion in the shape data based on the accepted designation contents and stores the information.

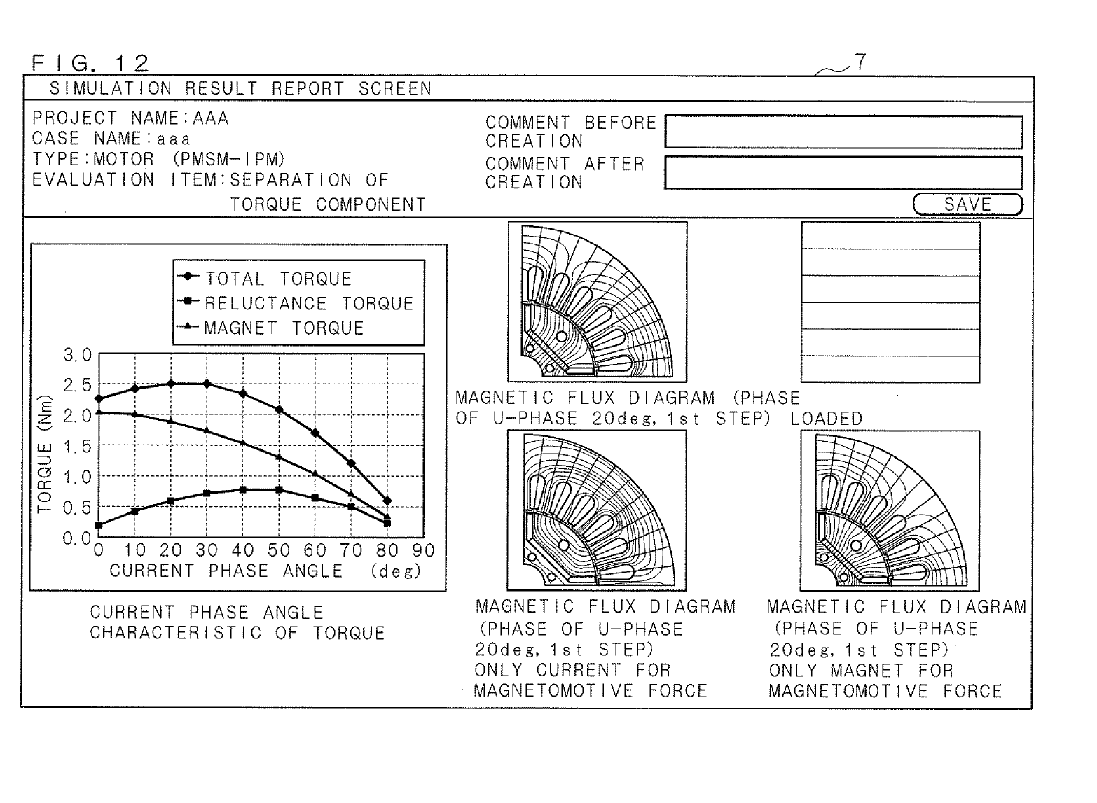

FIG. 12 is a schematic view illustrating an example of a screen for a simulation result report (hereinafter also referred to as “simulation result report screen”). The simulation result report screen shows a graph, a contour diagram and the like indicating the result obtained in accordance with the coupled analysis procedure. For example, the CPU 11 executes the coupled analysis simulation in accordance with the coupled analysis procedure illustrated in the flow chart 61 in FIG. 11 regarding the separation analysis for the torque component of the motor, to make the display portion 14 show a flux diagram obtained by analyzing the magnet torque, a flux diagram obtained by analyzing the reluctance torque, a flux diagram obtained by analyzing the total torque and a graph representing a torque obtained by each analysis.

At step S18, the CPU 11 can also display details of the analysis result in accordance with the user's instructions. This will be described later in detail.

The CPU 11 also executes an execution procedure part of one simulation means included in the coupled analysis procedure independently of the execution procedure part of another simulation means, in accordance with the user's instructions (step S19). This will be described later in detail.

The CPU 11 further executes the processing of executing a certain execution procedure part included in the coupled analysis procedure independently of another execution procedure part (Step S20). This will be described later in detail.

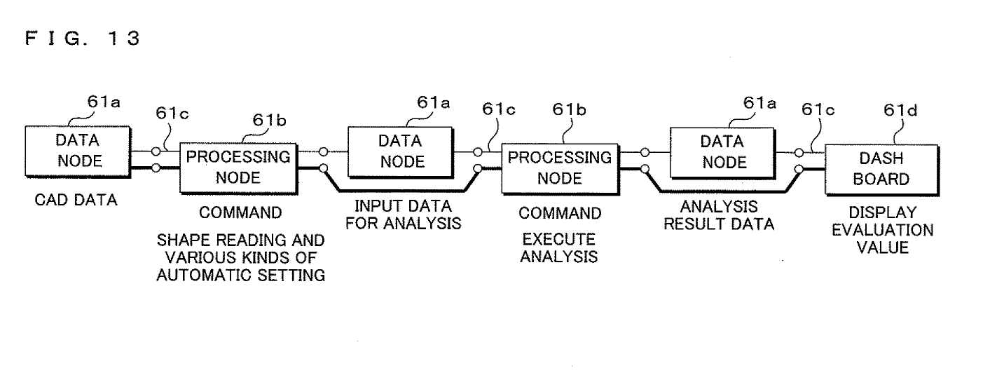

FIG. 13 is a data flow chart conceptually illustrating the coupled analysis by a data node 61a. While the procedure of the coupled analysis simulation is as described above, it is configured, in the present embodiment, to write and read the data on the result of analysis to/from a file of a predetermined form when the analysis result is transmitted between a plurality of simulators.

When the procedure for transmitting the result of analysis from the first simulator to the second simulator is described in the coupled analysis procedure, the first simulator transmits data through the processing procedure of creating a file of a predetermined data form including the result of simulation, reading out the result of simulation from the file of the predetermined data form and simulating the behavior of an object.

The data node 61a shown in FIG. 13 is a block indicating various types of data that are present as files of a predetermined form, while the processing node 61b is a block for defining a method of processing the various types of data. The processing node 61b has an input command for inputting data regarding a specific data node 61a, a command for operating a simulator using the read-out data, and an output command for outputting the processing result as the specific data node 61a. The dash board is a block for executing the processing for displaying the result of simulation related to an evaluation item. The thick lines connecting the processing nodes 61b conceptually represent the flow of signals, while each of the thin lines connecting the processing nodes 61b and data nodes 61a represents a link 61c indicating the actual flow of data.

Furthermore, since the data node 61a is clearly expressed in the flow chart 61 as shown in FIGS. 9 and 11, the procedure of data transmission is made clear. By clarifying transmission of data, one processing included in the coupled analysis procedure may independently be executed or a part of the coupled analysis procedure may be executed by partial execution. Moreover, original data such as the graph or the like of the result of analysis can easily be seen, so that a detailed result of analysis based on the original data may be displayed as required, in addition to a simplified display of the analysis result. This can also facilitate diversion of a part or all of the coupled analysis procedure to another coupled analysis simulation.

The block in the dashboard is a processing block for forming and displaying the contents of the simulation result for an evaluation item in such a manner that a person not skilled in the field of coupled analysis can easily check and evaluate the result. In the conventional coupled analysis or a combination of complicated analyses, after execution, the user him/herself needs to activate each simulator, to search for a file related to a result displayed on the simulation result report screen and to analyze the setting or result in detail. Such procedures, however, can only be performed by a specialist or researcher of analysis, not by a local designer. Therefore, an environment is provided, in which a specialist or researcher of analysis defines, in advance, what to be evaluated in addition to the procedure for coupled analysis on a dashboard such that a local designer needs only to prepare a shape and execute the procedure to see a list of necessary information on the dashboard. It is, however, difficult to search for original result data, on which calculated values are based, from the generalized simulation result report. To address this, for example, when a point on a graph is clicked, an automatic procedure is performed to search for a file including the corresponding original result data, to start up the corresponding simulator and to read the result. This will be described later in detail.

The independent execution and partial execution of the coupled analysis simulation as well as outputting of a result of analysis will now be described below.

### <Independent Execution>

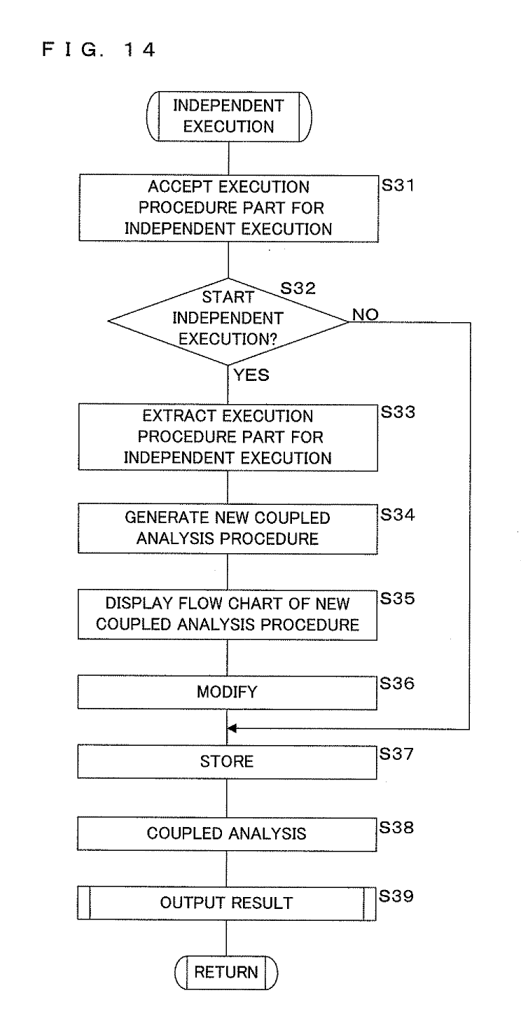

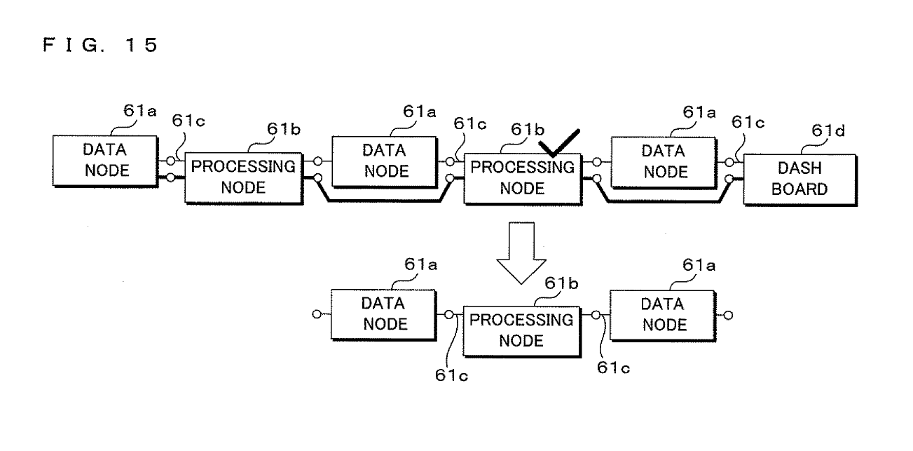

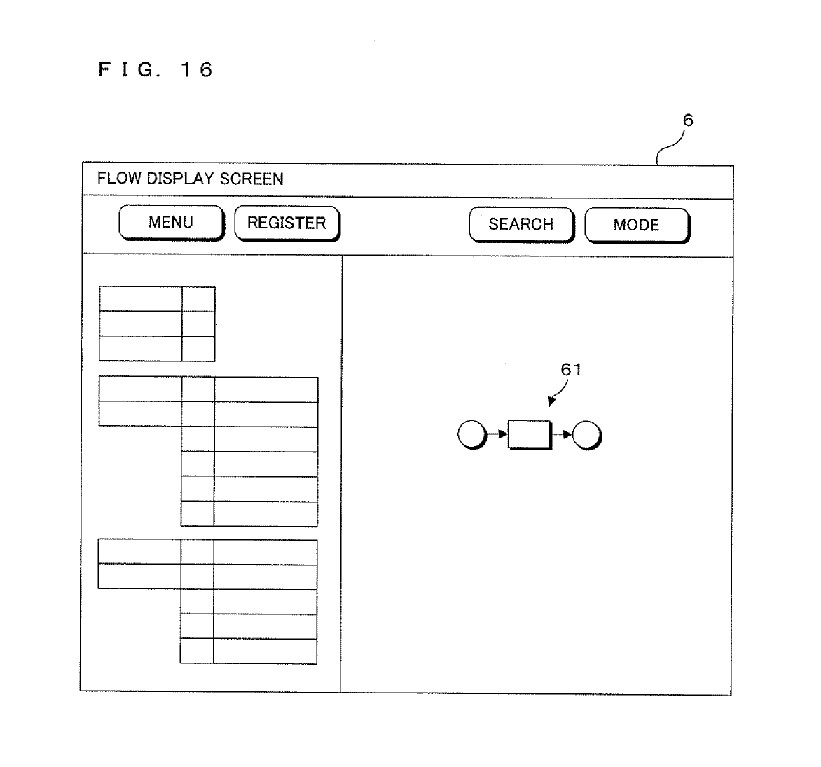

FIG. 14 is a flow chart illustrating a processing procedure of a subroutine regarding independent execution. FIG. 15 is a data flow chart conceptually illustrating a method of independent execution processing. FIG. 16 is a schematic view illustrating an example of a flow display screen 6 for displaying the portion of a processing node 61b for independent execution. The CPU 11 accepts an execution procedure part for independent execution from the flow chart 61 displayed on the flow display screen 6 (Step S31) and determines whether or not the independent execution is to be started (Step S32). The user can designate the processing node 61b for independent execution by attaching a check mark to the processing node 61b, as shown in FIG. 15. If it is determined that the independent execution is not to be started (Step S31: NO), the CPU 11 terminates the processing.

If it is determined that the independent execution is to be started (Step S31: YES), the CPU 11 extracts the execution procedure part for independent execution (Step S33), generates a new coupled analysis procedure including the extracted execution procedure part (Step S34), crates the flow chart 61 indicating the new coupled analysis procedure as shown in FIG. 16, and makes the display portion 14 display the flow chart 61 (Step S35). The CPU 11 then accepts a modification such as deleting a part of the coupled analysis procedure or adding another processing execution procedure, to perform the modification on the coupled analysis procedure in accordance with the user's instructions (Step S36). The CPU 11 then stores the new coupled analysis procedure (Step S37).

Thereafter, the simulator is operated in accordance with a command for the extracted portion of the processing node 61b (Step S38), to output a result of analysis (Step S39).

It is also possible to perform independent execution on a plurality of processing nodes 61b at the same time. If the processing is not continuous, it may sequentially be executed or executed through distributed processing by a plurality of machines.

As described above, since the data regarding input and output is clarified as the data node 61a, a certain execution procedure part designated by the user can easily be extracted from the coupled analysis procedure to be independently executed as a whole new coupled analysis procedure. As this is a new coupled analysis procedure, a modification such as an addition and a deletion to and from the procedure can be performed. It is understood that, though the processing of the independent execution can be used for testing the original coupled analysis procedure, it is mainly directed to a diverted use of the coupled analysis procedure.

### <Partial Execution>

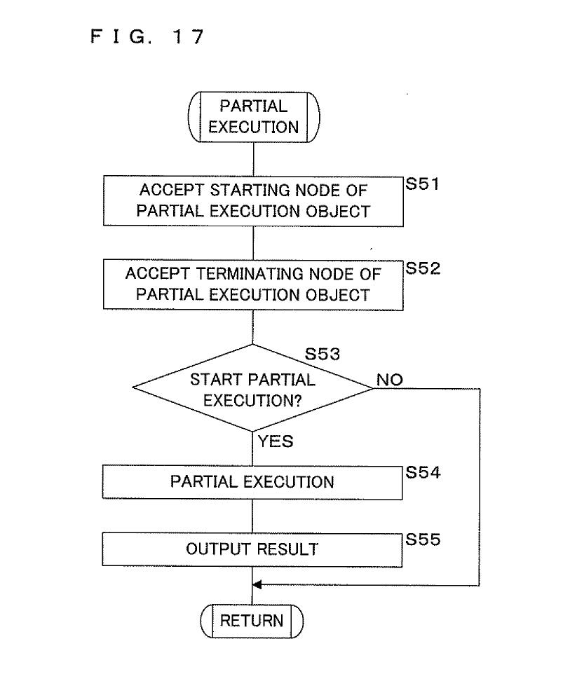

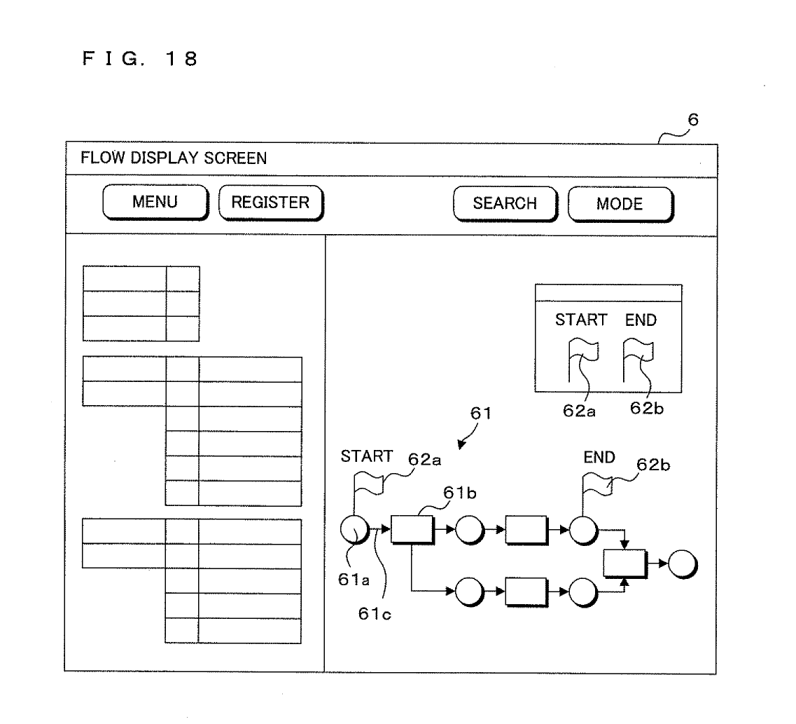

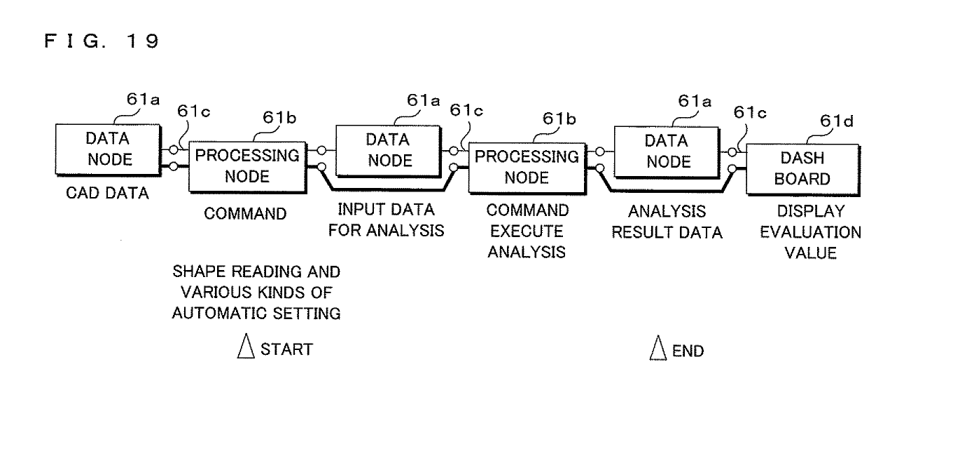

FIG. 17 is a flow chart illustrating a processing procedure of a subroutine regarding partial execution. FIG. 18 is a schematic view illustrating an example of a flow display screen 6 for accepting an object to be partially executed (hereinafter also referred to as “partial execution object”). FIG. 19 is a data flow chart conceptually illustrating a method of partial execution processing. The CPU 11 accepts a starting node of the partial execution object (Step S51) and accepts a terminating node from the flow chart displayed on the flow display screen 6 (Step S52). The user can, as shown in FIG. 18 for example, apply an icon 62a for designating the starting node to the processing node 61b which is the beginning of the partial execution object, to designate the starting node. Likewise, the user can apply an icon 62b for designating the terminating node to the processing node 61b which is the end of the partial execution object, to designate the terminating node.

The CPU 11 then determines whether or not the partial execution is to be started (Step S53). If it is determined that the partial execution is not to be started (Step S53: NO), the CPU 11 terminates the processing. If it is determined that the partial execution is to be started (Step S53: YES), the CPU 11 executes by partial execution a part of the coupled analysis procedure designated at the Steps S51, 52 (Step S54), and outputs the result of analysis (step S55).

As described above, the data regarding input and output is defined as the data node 61a, thereby facilitating reading of data required for executing a part of the coupled analysis procedure by partial execution, independent execution of the processing for the corresponding part, and output of the processing result. The output result can also easily be seen. In other words, only a designated execution procedure part can be executed without any change in the original coupled analysis procedure itself. The processing of partial execution is, unlike the independent execution, not directed to a modification such as addition or deletion but is mainly directed to a better understanding of the coupled analysis procedure or an analysis at the time of operation failure by executing and evaluating a taken-out part of the complicated coupled analysis flow.

### <Output of Analysis Result>

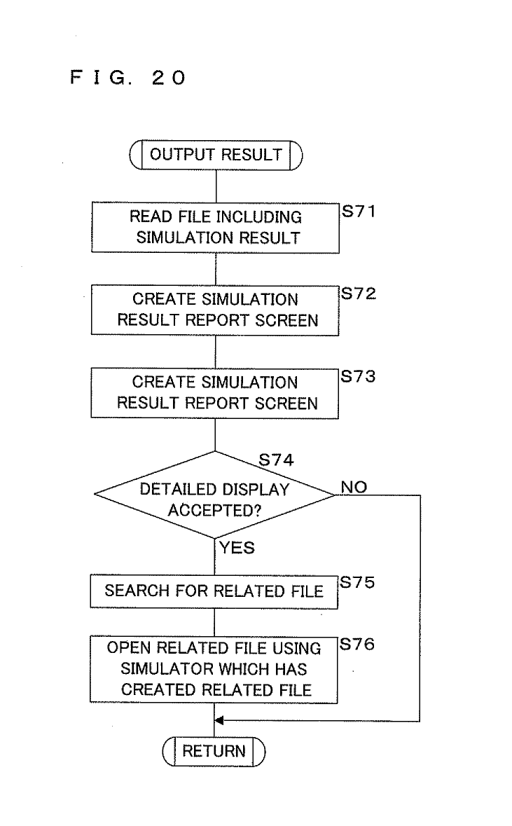

FIG. 20 is a flow chart illustrating a processing procedure of a subroutine regarding an output of an analysis result. When the coupled analysis of Step S19 is completed, the CPU 11 reads out data from a file including a simulation result (Step S71), creates a simulation result report screen as shown in FIG. 12 from the read out data in the file (Step S72), and makes the display portion 14 display the created simulation result report screen in a simplified manner (Step S73).

Subsequently, the CPU 11 accepts the detailed display of the result of analysis (Step S74). If it is determined that the detailed display is not accepted (Step S74: NO), the CPU 11 terminates the processing. If it is determined that the detailed display is accepted (Step S74: YES), the CPU 11 uses the flow of the coupled analysis procedure to search for a related file having original data regarding the content of the result in the simplified display (Step S75), and uses the simulator which has created the identified related file to open the related file (Step S76). If, for example, the user selects a magnetic flux diagram illustrated in FIG. 12 with a cursor (not shown), the CPU 11 identifies a related file having the data from which the flux diagram is created and makes the simulator for executing an electromagnetic analysis open the related file.

There are various possible ways of identifying the related file. For example, the control portion can track back the coupled analysis procedure to identify the data node 61a, i.e. file, on which the analysis result in the simplified display is based. Alternatively, an image of the analysis result in the simplified display may include the name, location and the like of a file having data on which the result is based. The information included in the image may then be used to identify the related file when a detailed display is shown.

Moreover, a numeric value counted by a loop counter is stored in association with each simulation result, while the control portion stores the corresponding values of the loop counter such that the corresponding value can be tracked from the analysis result when a simplified display of the analysis result is shown. When displaying details of the analysis result, a numeric value of the loop counter may be used to identify the related file from which the analysis result is generated.

An example of the simulation result report screen, the search of the related file and the processing for opening a related file using the simulator will now be described below.

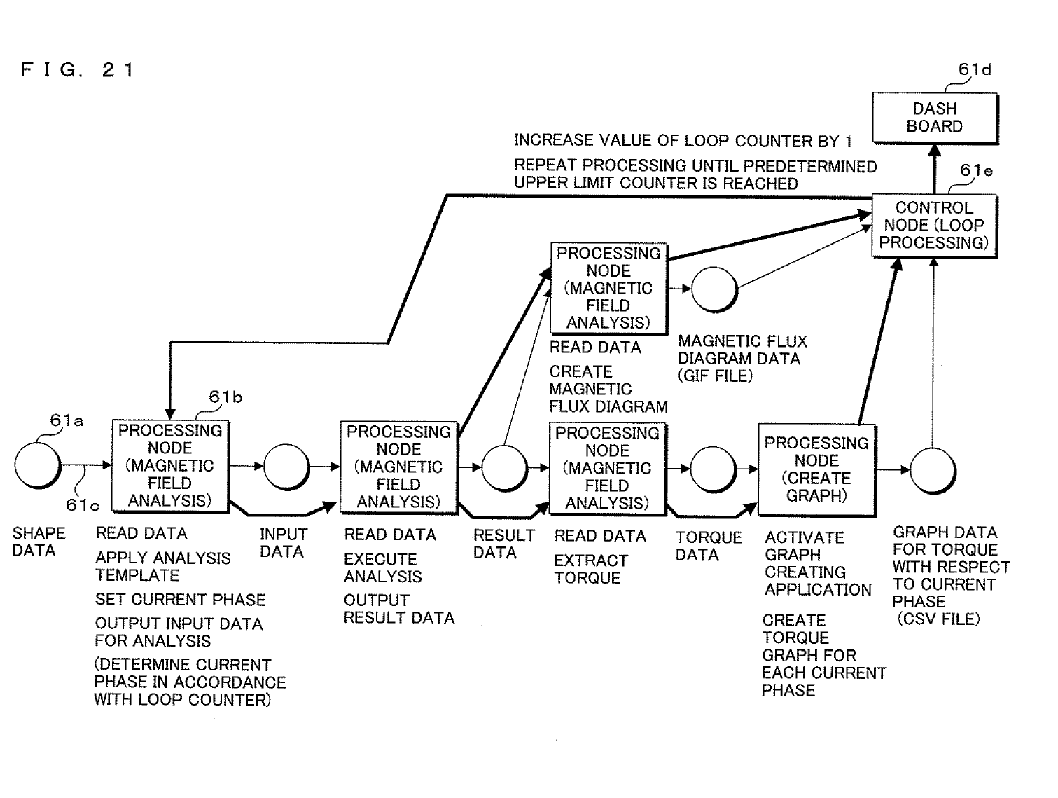

FIG. 21 is a flow chart illustrating an example of the coupled analysis procedure. The coupled analysis procedure shown in FIG. 21 is to create a graph representing the relationship between the torque and the electric current phase of the motor. More specifically, at the processing node 61b on the left side, a model is created based on shape data and an analysis template is employed, while a current phase is determined in accordance with a value of the loop counter. These are output as input data. The analysis template is a saved form including conditions and result display items that are required for analyzing matters other than the shape. By connecting the template and the shape while setting and changing a parameter in accordance with a purpose of analysis, the processing node is made to satisfy the purpose. The loop counter has an initial value of 0. At the next processing node 61b, an electromagnetic field generated at the motor in the determined current phase is simulated, and data of the simulation result is output. Subsequently, data of a magnetic flux diagram is created at one processing node 61b based on the result data. The magnetic flux diagram data, e.g., a GIF file is output. At another processing node 61b, torque data is calculated and output. The torque data is plotted to a graph for each current phase to create graph data indicating a torque with respect to each current phase. For example, a CSV file is created. When the creation of a magnetic flux diagram and calculation of torque in an electric current phase is completed, the control node increases the value of the loop counter by one, and repeatedly executes creation of magnetic flux diagram and calculation of torque until the value reaches a predetermined upper limit. The magnetic flux diagram data and torque data are stored in association with each value of the loop counter. When the value of the loop counter reaches the upper limit, the dashboard creates and displays a simulation result report screen based on the magnetic flux diagram data and the graph data. Though FIG. 21 shows the coupled analysis procedure for calculating normal torque data, a magnet torque and a reluctance torque may similarly be calculated while the dashboard displays a simulation result report screen for each torque.

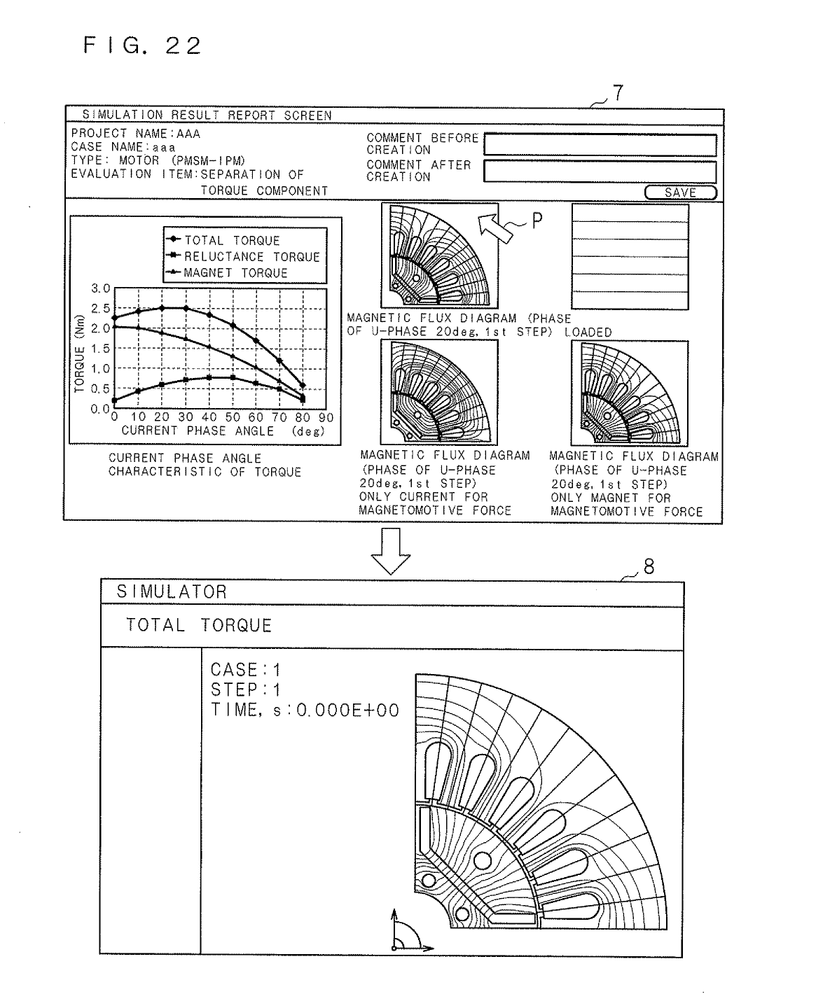

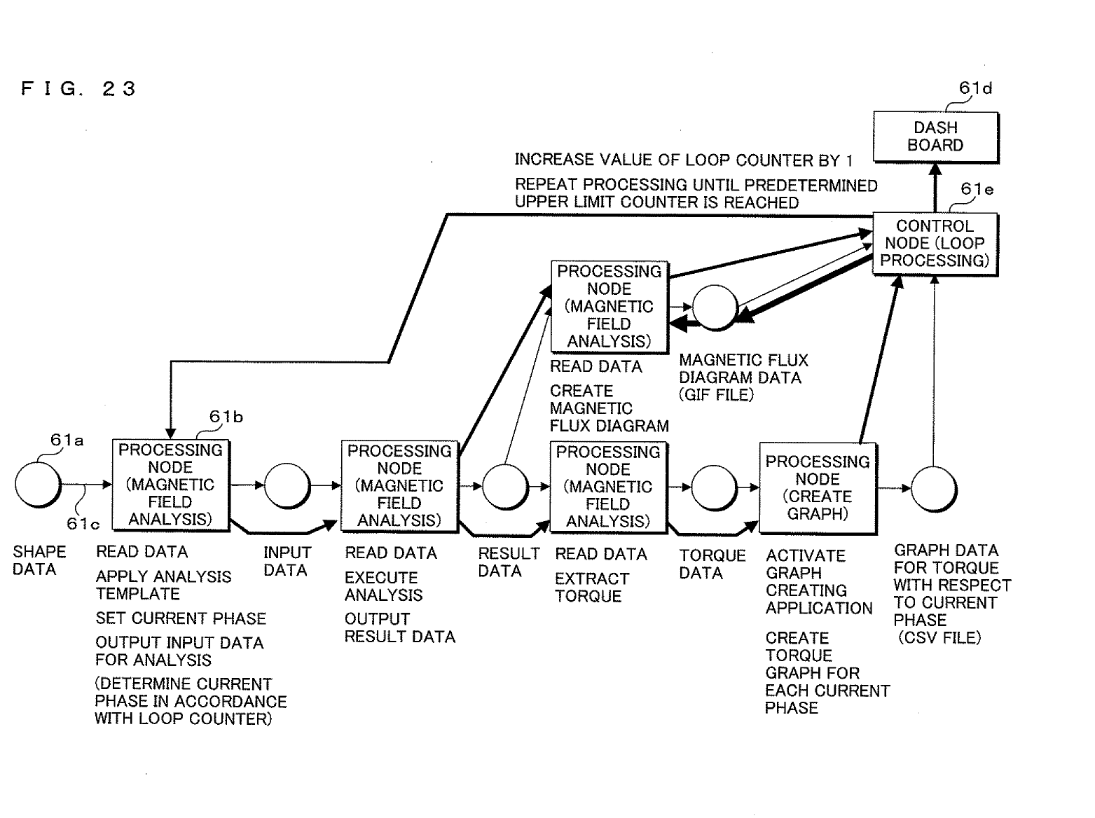

FIG. 22 is a schematic view illustrating a simulation result report screen and a start-up screen for a related file by a simulator. FIG. 23 is a conceptual view illustrating a method of searching for a related file. On a simulation result report screen, when, for example, a specific flux diagram is selected with a pointer P, the CPU 11 searches for a file of the flux diagram data by following the coupled analysis procedure, to execute processing for making a simulator which has created the file, i.e. flux diagram, open the file. As such, the processing for the processing node 61b for which a magnetic flux diagram is created can be performed again. The user can check and see the details of the simulation result of the magnetic flux, which cannot be analyzed in the simulation result report screen, by starting up the simulator which has created an original file.

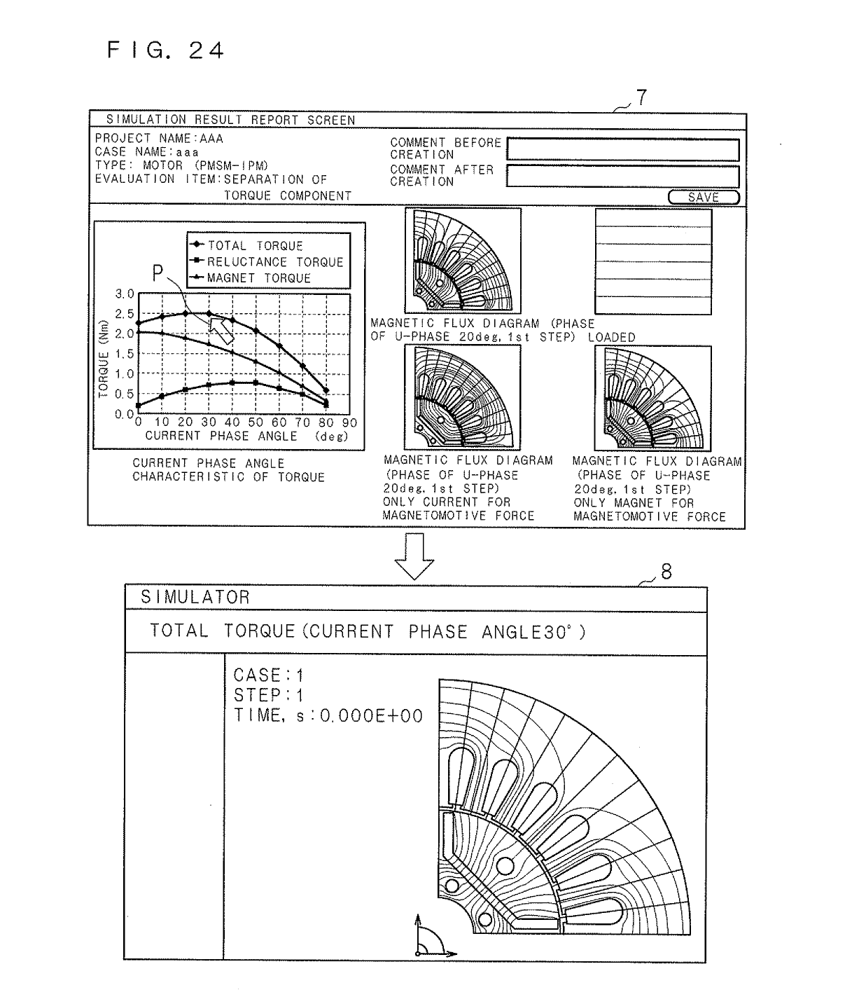

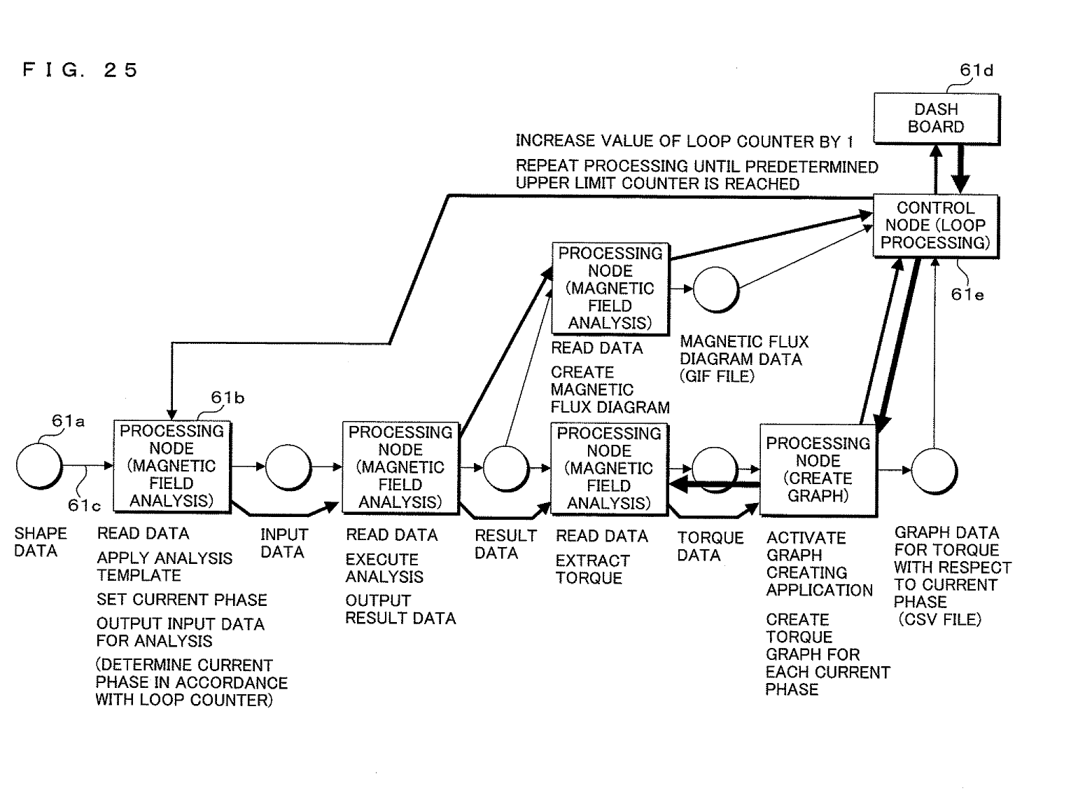

FIG. 24 is a schematic view illustrating a simulation result report screen and a start-up screen for another related file by a simulator. FIG. 25 is a conceptual view illustrating a method of searching for another related file. On the simulation result report screen, when, for example, one of the points plotted in the graph indicating torque with respect to current phase is selected by the pointer P, the CPU 11, as shown in FIG. 25, specifies a value of the loop counter corresponding to a point in the plot, searches for a file corresponding to the point based on the specified value of the loop counter, and executes the process of making the simulator which has created the file, i.e. the simulator which has calculated the torque, open the file. The user can check and see the details of the simulation result for torque which cannot be analyzed on the simulation result report screen by starting the simulator which has created the original file.

When an object is evaluated, a simulation result needs to be analyzed. To analyze the simulation result, however, a graph and a magnetic flux diagram displayed in a simplified manner are not enough. In the conventional simulation apparatus, it is necessary to check the coupled analysis procedure in detail to search for the location of data from which an image of a simulation result displayed in a display portion is created. In the present embodiment, only by designating a simply-displayed analysis result, e.g., by clicking with a cursor, a file of data from which the result is generated can be read by a simulator which has created the file and can be started up. Thus, details of the analysis result can also be checked with a simulator utilized by a specialist in each field.

In the conventional simulation apparatus, if, as shown in FIG. 21, recursive repetitive processing is performed in any processing in the coupled analysis procedure, or if the size of the analysis procedure flow is increased to a large degree, it becomes quite complicated and difficult to search for and open the file storing the result of simulation. In the example shown in FIG. 21, in the characteristic evaluation for the motor, for example, a large number of analyses with different electric current phases are performed to form a graph representing the relationship between each current phase and a mean value of torque for each rotation position obtained from a calculated result. Here, when the user wishes to analyze a reason why such a torque is obtained at one current phase, the corresponding result file in the coupled analysis flow is opened by only clicking a point of the graph, which is very convenient. If no effort is made as in the conventional simulation apparatus, the user needs to perform cumbersome and daunting operation, i.e., searching for a result file which should be located somewhere because calculation is executed for each current phase somewhere unknown in the computer, or, if the file is found, reading the file by activating unfamiliar analysis software.

According to the present embodiment, a complicated coupled analysis can automatically be executed only by preparing shape data of a simulation object and selecting a type of object and an evaluation item. Thus, the evaluation item can easily be checked. Furthermore, a simulator which has calculated a related result can be activated to directly show the result by only clicking a part of a graph and a figure which are made compact in a report form as in the simulation result report screen.

As described above, the present embodiment allows transfer of the know-how of the coupled analysis and simplification of the complicated coupled analysis processing. The know-how includes at least (1) how a real machine is to be recognized as a physical phenomenon and modeled, and (2) which one of various calculation results after analysis is to be used for evaluation.

In the present embodiment, the coupled analysis is given general versatility, while a performance evaluation utilizing the coupled analysis simulation can easily be executed. Thus, a designer who does not necessarily have a special knowledge of analyses can easily use the coupled analysis procedure which is a bundle of know-how constructed by a team of specialists with abundant knowledge of analysis simulation in each field, and can also easily divert the coupled analysis procedure.

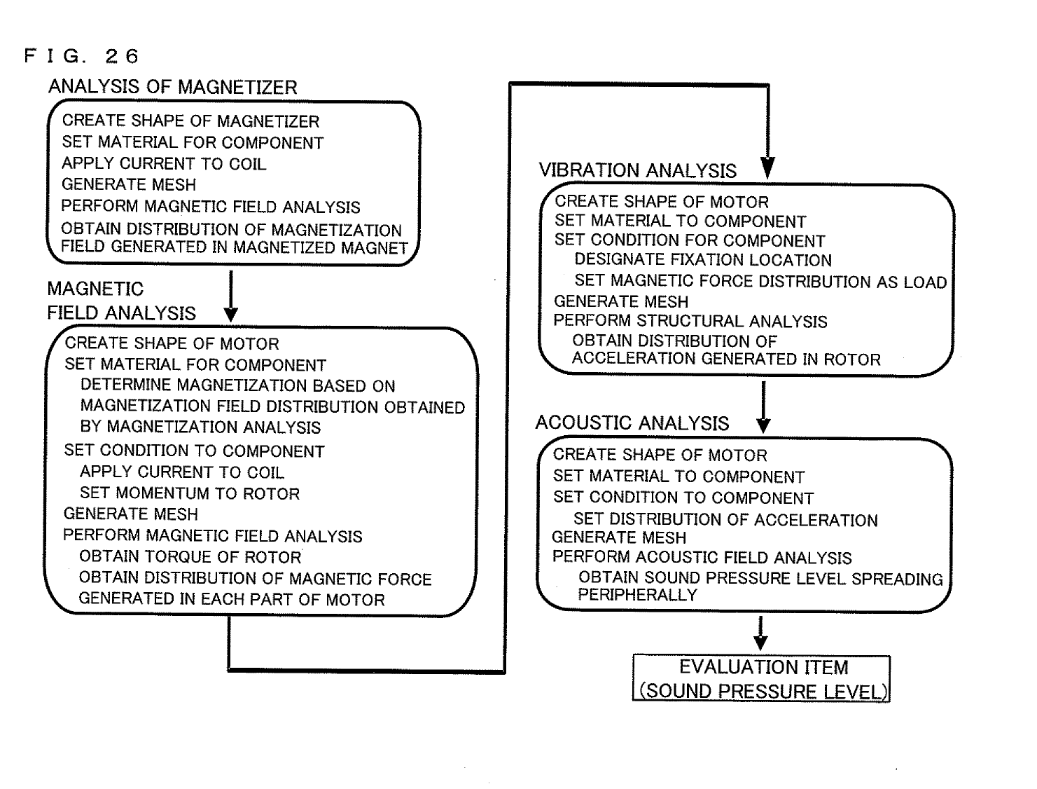

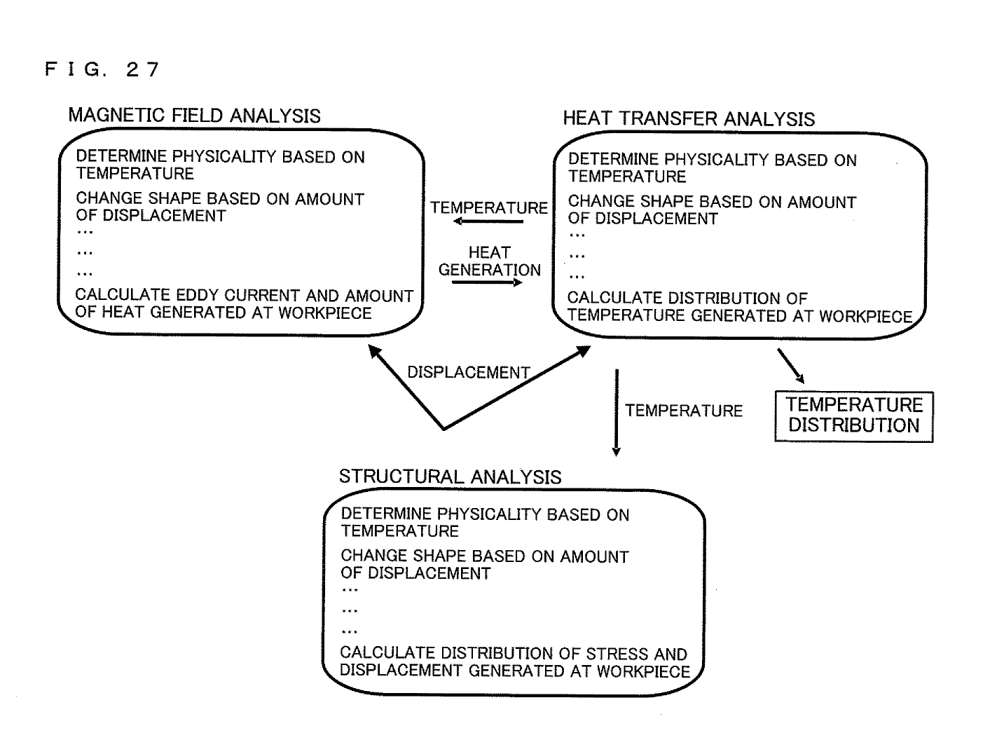

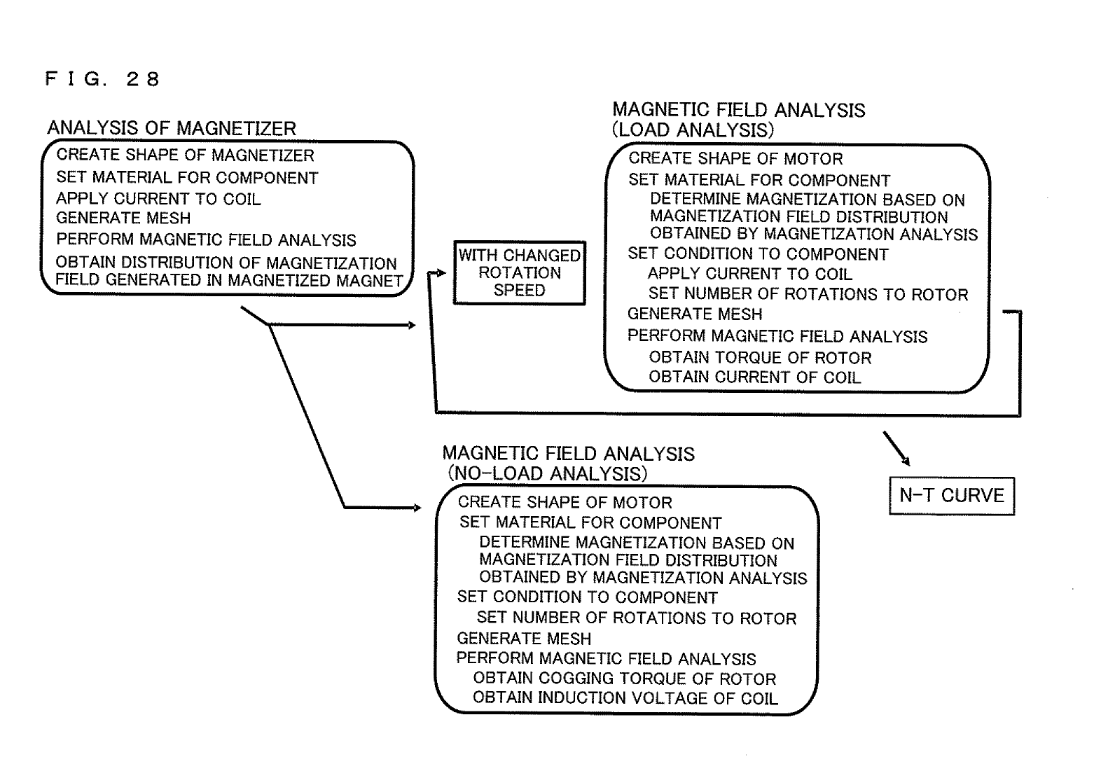

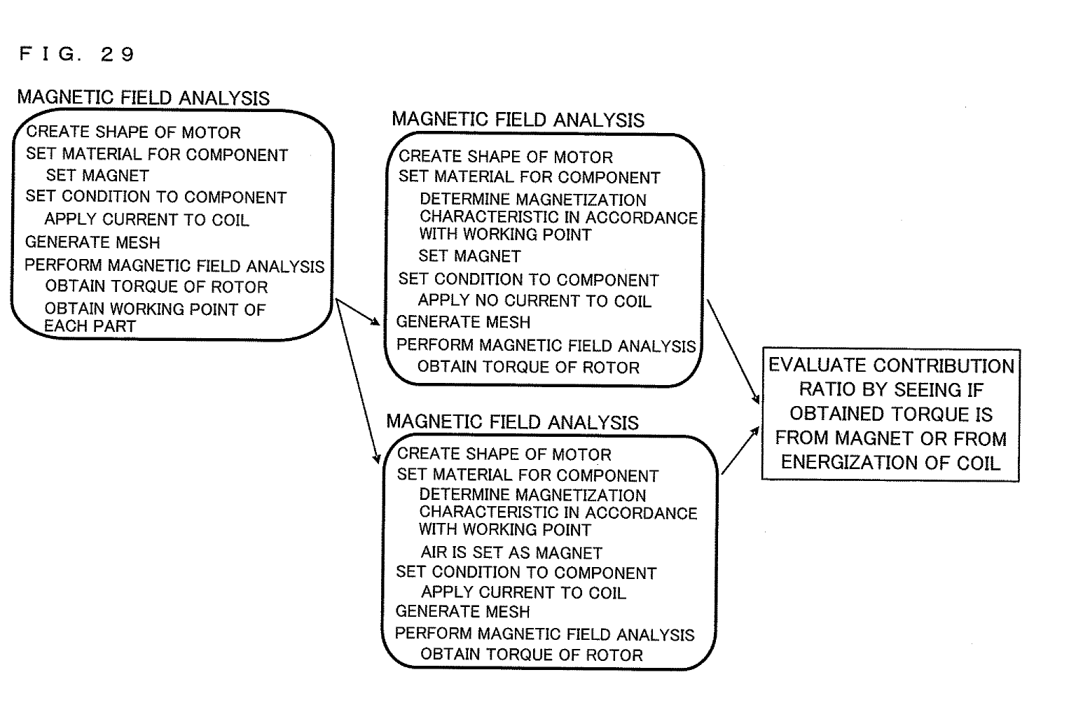

FIG. 26 is a conceptual view illustrating a method of coupled analysis for evaluating noise generated from a motor in consideration of imperfect magnetization of a magnet. FIG. 27 is a conceptual view illustrating a method of coupled analysis for evaluating a rise in temperature in consideration of thermal expansion at the time of energization heating or induction heating. FIG. 28 is a conceptual view illustrating a method of coupled analysis for obtaining a basic characteristic of a motor. FIG. 29 is a conceptual view illustrating a method of coupled analysis related to a separation analysis for a torque component. The coupled analysis shown in FIG. 26 is a representative example of sequential performed analyses with different purposes. FIG. 27 is a representative example of loop processing in which a plurality of analyses are complicatedly intertwined on a time axis to interact with each other. FIG. 28 is a representative example of branch processing performed in parallel with the magnetic field analysis in order to obtain a plurality of characteristics. FIG. 29 is a representative example for branch processing performed in parallel with the magnetic field analysis in order to analyze components of a characteristic. As shown in the figures, even if the coupled analysis procedure is conceptually simplified, it is still complicated to perform procedures for any one of the evaluation items including “noise generated from a motor in consideration of imperfect magnetization of a magnet,” “rise in temperature in consideration of thermal expansion at the time of energization heating or induction heating,” “basic characteristic of a motor” and “separation analysis for torque components.” The use of the simulation apparatus according to the present embodiment allows diversion of know-how for such a complicated coupled analysis procedure, thereby facilitating the execution of the coupled analysis.

Moreover, the data regarding input and output is defined as the data node 61a, so that a certain execution procedure part included in the coupled analysis procedure can be extracted to generate a procedure for another coupled analysis different from the above-described procedure. It is, therefore, possible to take out a part of the coupled analysis procedure to divert it to the procedure for another coupled analysis. Furthermore, the operation of a corresponding part can be checked by taking out a part of the coupled analysis procedure.

In addition, since the data regarding input and output is defined as the data node 61a, a part of the complicated coupled analysis procedure can easily be taken out to be executed and evaluated for better understanding of the coupled analysis procedure or for easy analysis at the time of an operation failure.

Furthermore, the result of various types of simulation obtained through the coupled analysis can be displayed as a compact graph and figure in a report form as in the simulation result report screen. Moreover, only by clicking a part of the graph and figure, a related file on which the graph and figure are based is automatically be searched for, so that the file can be displayed by activating the simulator which has created the related file. It is, therefore, possible for the user who is not a specialist to check details with a simulator used by a specialist in each field.

It should be understood that the present embodiment disclosed herein is illustrative and not restrictive in all aspects. The scope of the invention is defined by the appended claims rather than by the description preceding them, and all changes that fall within metes and bounds of the claims, or equivalence of such metes and bounds thereof are therefore intended to be embraced by the claims.

1-10. (canceled)

11. A simulation apparatus, comprising:
a shape data obtaining unit for obtaining shape data expressing a simulation object;
a constraint condition storage unit for storing a constraint condition for a simulation in association with each type of object;
a coupled analysis procedure storage unit for storing, for each of one or more evaluation items for evaluating an object having an arbitrary shape satisfying the constraint condition, a procedure of a coupled analysis using one or more simulation units related to the evaluation item;
an accepting unit for accepting a type of an object regarding the obtained shape data and an evaluation item for the object;
a reading unit for reading out a procedure of a coupled analysis corresponding to the evaluation item from the coupled analysis procedure storage unit based on the accepted evaluation item for the object; and
a coupled analysis unit for reading out a constraint condition for an object corresponding to the accepted type from the constraint condition storage unit, giving the constraint condition to the shape data, and executing the coupled analysis using said one or more simulation units in accordance with the procedure of the coupled analysis read out by the reading unit.

12. The simulation apparatus according to claim 11, comprising
a plurality of simulation units for simulating behavior of an object having an arbitrary shape satisfying the constraint condition based on one or more different governing equations.

13. The simulation apparatus according to claim 11, wherein
said one or more simulation units is configured to simulate or optimize behavior of an object based on a governing equation expressing an electromagnetic behavior, mechanical behavior, thermal behavior, behavior related to an electric circuit or fluxional behavior of the object, or based on an optimizing method for each behavior.

14. A simulation apparatus according to claim 11, comprising
a unit for displaying a flow chart illustrating the procedure of the coupled analysis read out by the reading unit, wherein
the flow chart includes
a processing node indicating processing to be executed by the simulation unit,
a data node indicating data to be input or output by the simulation unit.

15. The simulation apparatus according to claim 14, comprising
a unit for extracting a certain execution procedure part included in the procedure of the coupled analysis read out by the reading unit and generating a procedure for another coupled analysis different from said procedure.

16. The simulation apparatus according to claim 14 or 15, comprising
partial execution unit for executing a certain execution procedure part included in the procedure of the coupled analysis read out by the reading unit independently of another execution procedure part.

17. The simulation apparatus according to claim 16, comprising
a unit for displaying a designation image on the flow chart for designating a beginning and an end of a certain execution procedure part included in the procedure of the coupled analysis, wherein
the partial execution unit is configured to execute the execution procedure part designated by the designation image independently from another execution procedure part.

18. The simulation apparatus according to claim 11, wherein
the simulation unit includes unit for creating a file including a simulation result,
the simulation apparatus further comprising:
a result display unit for displaying in a simplified manner a simulation result regarding the evaluation item based on the file;
a detailed display accepting unit for accepting a detailed display of the simulation result displayed by the result display unit;
a unit for searching for a file related to the simulation result accepted by the detailed display accepting unit; and
a unit for making the simulation unit which has created the file related to the simulation result open the file.

19. A simulation method for simulating behavior of an object using a simulation apparatus comprising
obtaining shape data for an object;
accepting a type of an object regarding the obtained shape data and an evaluation item for the object;
reading out a procedure of a coupled analysis corresponding to the evaluation item, based on the accepted evaluation item of the object, from a coupled analysis procedure storage unit for storing, for each of one or more evaluation items for evaluating an object having an arbitrary shape satisfying a constraint condition for a simulation, a procedure of a coupled analysis using one or more simulation units related to the evaluation item; and
reading out a constraint condition of an object corresponding to the accepted type from a constraint condition storage unit for storing a constraint condition for a simulation in association with each type of simulation object, giving the constraint condition to the shape data, and executing the coupled analysis using said one or more simulation units in accordance with the read-out procedure of the coupled analysis.

20. A non-transitory computer-readable recording medium storing a computer program for making a computer simulate behavior of an object, the computer program making the computer function as:
one or more simulation units for simulating behavior of an object having an arbitrary shape satisfying a constraint condition for a simulation;
an accepting unit for accepting a type of an object regarding the shape data of the object and an evaluation item for the object;
a reading unit for reading out a procedure of a coupled analysis corresponding to the evaluation item, based on the accepted evaluation item for the object, from a coupled analysis procedure storage unit for storing, for each of one or more evaluation items for evaluating an object having an arbitrary shape satisfying a constraint condition for a simulation, a procedure of a coupled analysis using said one or more simulation units related to the evaluation item; and
a coupled analysis unit for reading out a constraint condition for an object corresponding to the accepted type from a constraint condition storage unit for storing a constraint condition for a simulation in association with each type of simulation object, giving the constraint condition to the shape data, and executing the coupled analysis using said one or more simulation units in accordance with the procedure of the coupled analysis read out by the reading unit.
